(19) United States
(12) Patent Application Publication
(10) Pub. No.: US 2009/0219558 A1
(43) Pub. Date: Sep. 3, 2009

(54) IMAGE PROCESSING APPARATUS AND IMAGE PROCESSING METHOD

(75) Inventor: Naoya Murakami, Yokohama-shi (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/392,592

(22) Filed: Feb. 25, 2009

Related U.S. Application Data
(60) Provisional application No. 61/032,384, filed on Feb. 28, 2008.

(51) Int. Cl. G06K 1/00; H04N 1/387; G06F 3/12

(52) U.S. Cl. 358/1.13; 358/452; 358/1.15

(57) ABSTRACT

A digital multifunction peripheral has a copy mode for printing an image scanned by a scanner on a sheet using a printer, a network scan mode for transmitting the image scanned by the scanner to an external apparatus through a network interface, and a facsimile mode for transmitting by facsimile the image scanned by the scanner through a facsimile interface. The digital multifunction peripheral erases the same area from image data as an area on the outside of an original document image irrespective of processing contents in plural image processing units that subject the image scanned by the scanner to image processing according to operation modes. The digital multifunction peripheral performs processing corresponding to an operation mode using image data from which the area on the outside of the original document image is erased and that is processed by the image processing unit corresponding to the operation mode.

### CROSS-REFERENCE TO RELATED APPLICATION

This application claims the benefit of U.S. Provisional Application No. 61/032,384, filed Feb. 28, 2008.

### TECHNICAL FIELD

The present invention relates to an image processing apparatus such as a digital multifunction peripheral including processing units such as a scanner, a printer, a network interface, and a facsimile interface and an image processing method.

### BACKGROUND

A digital multifunction peripheral includes an image scanning apparatus (a scanner), an image forming apparatus (a printer), a network communication unit (a network interface), and a facsimile communication unit (a facsimile interface). The digital multifunction peripheral including such hardware copies an image on an original document to a sheet, transmits image data through a network, and transmits image data by facsimile. The digital multifunction peripheral functions as an image processing apparatus that processes input image data of, for example, an image scanned by the scanner. The digital multifunction peripheral has, as an image processing function for the image scanned by the scanner, an outside-of-document erasing function for erasing an unnecessary area (a black image portion) on the outside of an original document image. The outside-of-document erasing function is effective for image data obtained by the scanner scanning an original document in a state in which a document cover is opened. U.S. Pat. No. 5,629,777 discloses a technique for erasing an area on the outside of an original document from image data of the original document scanned in a state in which a document cover is opened in a monochrome digital multifunction peripheral. A method disclosed in U.S. Pat. No. 5,629,777 is a method of determining whether a density value of each of pixels in monochrome image data scanned by the scanner is likely to be a density value of pixels on the outside of the original document. With the method disclosed in U.S. Pat. No. 5,629,777, an area on the outside of the original document in the scanned image data is detected on the basis of a result of the determination and an image in an area determined as the outside of the original document is erased.

However, in the method disclosed in U.S. Pat. No. 5,629,777, a density value of each of pixels in a scanned image of an original document and a threshold are simply compared. Therefore, in the method disclosed in U.S. Pat. No. 5,629,777, an area crowded with pixels having a large density value in image data in an original document may be determined as an area on the outside of the original document by mistake. Further, in recent years, a color digital multifunction peripheral (color MFP) is widely spread. In the color digital multifunction peripheral, an image of an original document is scanned as a color image. In such a color digital multifunction peripheral, it is also necessary to distinguish an area on the outside of the original document and the other areas in color image data obtained as a scanned image of the original document.

### SUMMARY

It is an object of an embodiment of the present invention to provide an image processing apparatus and an image processing method for processing an input image to obtain the same level of a processing result irrespective of an operation mode.

According to an aspect of the present invention, there is provided an image processing apparatus including: a scanner that scans an image of an original document; plural processing units that process image data according to various operation modes; plural image converting units that convert image data scanned by the scanner into image data to be processed in processing units corresponding to the operation modes; an outside-of-document erasing unit that erases, as an area on the outside of the original document image, the same area irrespective of content of image conversion processing in the respective image converting units from the image data; and a control unit that supplies the image data from which the area on the outside of the original document image is erased by the outside-of-document erasing unit and that is processed by the image converting unit corresponding to an operation mode designated by a user to the processing unit corresponding to the operation mode.

According to another aspect of the present invention, there is provided an image processing method including: acquiring image data; converting the acquired image data into image data corresponding to an operation mode designated by a user; erasing an area on the outside of an original document image from the acquired image data with outside-of-document erasing processing for erasing, as an area on the outside of an original document image, the same area irrespective of content of conversion processing for image data corresponding to various operation modes; and performing, using the image data from which the area on the outside of the original document image is erased and that is converted into the image data corresponding to the operation mode designated by the user, processing corresponding to the operation mode.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic diagram of an external configuration of a digital multifunction peripheral;

FIG. 2 is a block diagram of the digital multifunction peripheral according to a first configuration example;

FIG. 3A is a diagram of an example of an image scanned in a state in which a document cover is opened;

FIG. 3B is a diagram of an example of an image obtained by erasing an area determined as the outside of an original document from the image shown in FIG. 3A;

FIG. 4A is a diagram of a spread-page book placed on a glass table in the state in which the document cover is opened;

FIG. 4B is a diagram of an example of an image obtained by scanning the book placed in the spread state shown in FIG. 4A;

FIG. 4C is an example of an image obtained by erasing an area determine as the outside of the original document from the image shown in FIG. 4B;

FIG. 5 is a diagram of a configuration example of an outside-of-document erasing unit;

FIG. 6 is a diagram of contents of input and output signals in a monochromization module;

FIG. 7 is a diagram of contents of input and output signals in a binarization module;

FIG. 8 is a diagram of contents of input and output signals in an outside-of-document erasing module;

FIG. 9 is a flowchart for explaining a flow of processing in the digital multifunction peripheral according to the first configuration example;

FIG. 10 is a block diagram of a digital multifunction peripheral according to a second configuration example;

FIG. 11 is a diagram of a configuration of an outside-of-document erasing unit in the digital multifunction peripheral according to the second configuration example;

FIG. 12 is a diagram of a setting example of binarization thresholds for respective operation modes in the digital multifunction peripheral according to the second configuration example;

FIG. 13 is a flowchart for explaining a flow of processing in the digital multifunction peripheral according to the second configuration example;

FIG. 14 is a block diagram of a digital multifunction peripheral according to a third configuration example;

FIG. 15 is a flowchart for explaining a flow of processing in the digital multifunction peripheral according to the third configuration example;

FIG. 16 is an external view of an overall configuration of an operation panel serving as an operation unit;

FIG. 17 is a diagram of an example of a setting screen for a user to designate intensity for determining the outside of an original document; and

FIG. 18 is a diagram of an example of a setting screen having a preview screen that displays an image showing an area on the outside of an original document to be erased by outside-of-document erasing processing.

### DETAILED DESCRIPTION

Embodiments of the present invention are explained below with reference to the accompanying drawings.

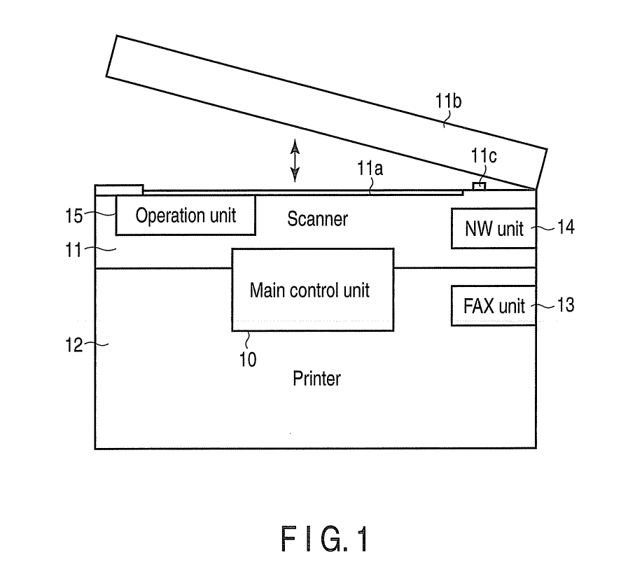

FIG. 1 is a schematic diagram of an overall configuration example of a digital multifunction peripheral 1.

The digital multifunction peripheral 1 shown in FIG. 1 is an image processing apparatus that functions as a copying machine, a scanner, a printer, a facsimile, and a network communication machine. In the configuration example shown in FIG. 1, the digital multifunction peripheral 1 includes a main control unit 10, a scanner 11, a printer 12, a facsimile communication unit (a FAX unit) 13, a network communication unit (an NW unit) 14, and an operation unit 15.

The main control unit 10 controls the entire digital multifunction peripheral 1. The main control unit 10 receives an operation instruction from a user in the operation unit 15 and controls the scanner 11, the printer 12, the facsimile communication unit 13, the network communication unit 14, and the operation unit 15. The main control unit 10 further includes an image processing unit that processes image data.

The scanner 11 scans an image on a recording medium (an original). The scanner 11 includes a not-shown scanning unit, a glass table 11a as a document placing table, a document cover 11b that covers the document placing table, and an open and close detector 11c that detects open and closed states of the document cover 11b.

The scanning unit is provided below the glass table 11a. The scanning unit converts an image of an original document set on the glass table 11a into image data. The scanning unit supplies the scanned image data to the main control unit 10. For example, the scanning unit includes a driving mechanism, a CCD line sensor, and a signal processing unit (all of which are not shown in the figure). The scanning unit is moved in a sub-scanning direction below the glass table 11a by a driving mechanism. The scanning unit scans, with the CCD line sensor, the image of the original document on the glass table 11a while moving in the sub-scanning direction. The CCD line sensor includes plural CCD sensors arranged in a main scanning direction with respect to the original document. The CCD line sensor converts reflected light from the original document into an analog image signal. The signal processing unit converts the analog image signal scanned by the CCD line sensor into a digital image signal.

In this embodiment, the scanner 11 scans the image of the original document as color image data formed by values of red (R), green (G), and blue (B) signals (pixel values of primary colors). In this embodiment, respective pixels (colors of the respective pixels) of the image data scanned by the scanner 11 are represented by a density value of R (hereinafter simply referred to as R), a density value of G (hereinafter simply referred to as G), and a density value of B (hereinafter simply referred to as B).

The glass table 11a functions as an original placing table for holding an original document to be scanned. The document cover 11b is configured such that the user can open and close the document cover 11b. In a closed state, the document cover 11b covers the entire glass table 11a. The document cover 11b also functions as a pressing member for pressing an original document placed on the glass table 11a. Open and closed states of the document cover 11b are detected by the open and close detector 11c. An auto document feeder (ADF) that feeds original documents one by one may be used as the document cover 11b.

A surface of the document cover 11b on the glass table 11a side is colored in, for example, white. Therefore, in a state in which the document cover 11b is closed, the CCD line sensor of the scanning unit can obtain reflected light having a minimum density value (maximum luminance) from an area on the outside of an original document (i.e., the white surface of the document cover 11b). Therefore, in the state in which the document cover 11b is closed, the CCD line sensor of the scanning unit scans the area on the outside of the original document as an image in which a density value is “minimum” (a luminance value is “maximum”). In other words, in the state in which the document cover 11b is closed, the scanning unit scans the area on the outside of the original document as white.

On the other hand, in a state in which the document cover 11b is opened, the CCD line sensor of the scanning unit cannot obtain reflected light from the area on the outside of the original document (reflected light from the original document). Therefore, in the state in which the document cover 11b is opened, the scanning unit scans the area on the outside of the original document on the glass table 11a as black. In other words, in the state in which the document cover 11b is opened, the scanning unit scans the area on the outside of the original document as a black image in which a density value is “maximum” (a luminance value is “minimum”).

The printer 12 forms a print image on an image formation medium. For example, when copying is performed, the main control unit 10 converts an image of an original document scanned by the scanner 11 into image data for printing. The printer 12 prints the image data of the original document processed for printing by the main control unit 10 on a copy sheet. A printer of an arbitrary image formation system can be applied as the printer 12. For example, the printer 12 may be a laser printer or may be an ink jet printer.

The facsimile communication unit (the FAX unit) 13 is an interface that performs transmission and reception of image data as facsimile data. The FAX unit 13 is connected to a telephone line. The FAX unit 13 transmits and receives the image data via the telephone line according to a facsimile transmission system. In this embodiment, the FAX unit 13 of the digital multifunction peripheral 1 transmits and receives monochrome image data. For example, when an image of an original document is transmitted by facsimile, the main control unit 10 converts the image of the original document scanned by the scanner 11 into image data for facsimile transmission. The FAX unit 13 transmits by facsimile the image data for facsimile transmission to a telephone number of a destination designated on the operation unit 15 according to the control by the main control unit 10.

The network communication unit (the NW unit) 14 is an interface for performing network communication of a LAN and the like. The NW unit 13 is connected to a network formed by a communication line or radio communication. For example, when the digital multifunction peripheral 1 is used as a network scanner, the main control unit 10 converts an image of an original document scanned by the scanner 11 into scan image data of a designated format. The NW unit 14 transmits the scan image data processed by the main control unit 10 to an apparatus (e.g., a user terminal) at a destination on a network designated on the operation unit 15.

The operation unit 15 is an operation unit on which the user inputs an operation instruction or guidance is displayed for the user. The operation unit 15 includes a display device and operation keys. For example, the operation unit 15 includes a liquid crystal display device incorporating a touch panel and hard keys such as a ten key.

The digital multifunction peripheral 1 according to a first configuration example of the digital multifunction peripheral is explained below.

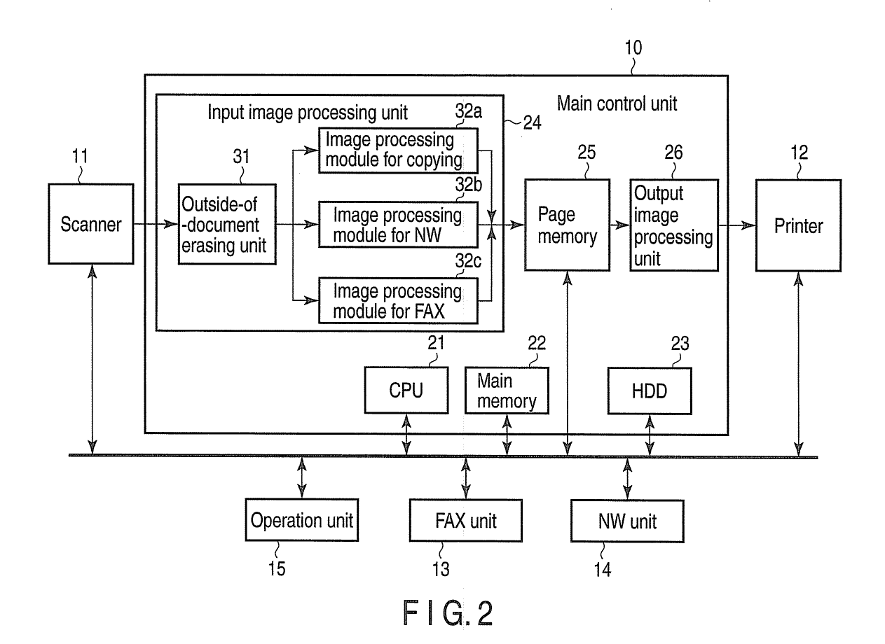

FIG. 2 is a block diagram of the digital multifunction peripheral 1 and the main control unit 10 according to the first configuration example.

As shown in FIG. 2, the main control unit 10 includes a CPU 21, a main memory 22, an HDD 23, a scanner-system image processing unit (an input image processing unit) 24, a page memory 25, and a printer-system image processing unit (an output image processing unit) 26.

The CPU 21 manages control of the entire digital multifunction peripheral 1. The CPU 21 realizes various functions by executing, for example, programs stored in a not-shown program memory. The main memory 22 is a memory in which work data and the like are stored. The CPU 21 realizes various kinds of processing by executing various programs using the main memory 22.

For example, the CPU 21 realizes copy control by controlling the scanner 11 and the printer 12 according to a program for copy control. In other words, when the CPU 21 executes the program for copy control, the digital multifunction peripheral 1 functions as a copy machine. The CPU 21 realizes a facsimile function by controlling the scanner 11 and the facsimile communication unit 13 according to a program for facsimile control. In other words, when the CPU 21 executes the program for facsimile control, the digital multifunction peripheral 1 functions as a facsimile apparatus. Further, the CPU 21 realizes network scan by controlling the scanner 11 and the network communication unit 14 according to a program for network scan control. In other words, when the CPU 21 executes the program for network scan control, the digital multifunction peripheral 1 functions as a network scanner.

The HDD (hard disk drive) 23 is a nonvolatile large-capacity memory. For example, the HDD 23 stores image data. The HDD 23 stores setting values (default setting values) in various kinds of processing. Further, the HDD 23 may store programs to be executed by the CPU 21.

The input image processing unit 24 processes an input image. In the first configuration example shown in FIG. 2, the scanner 11 functions as a scanner-system image processing unit that processes, as an input image, an image scanned by the scanner 11. The input image processing unit 24 processes, according to an operation mode of the digital multifunction peripheral 1, the image data scanned by the scanner 11. The CPU 21 indicates processing content corresponding to the operation mode to the input image processing unit 24.

Various kinds of image processing by the input image processing unit 24 may be realized by the CPU 21 executing a program for image processing. An image input to the input image processing unit 24 is not limited to image data input from the scanner 11. For example, the input image processing unit 24 may process, as an input image, image data received by the NW unit 14 through the network or image data received by the FAX unit 13 through facsimile communication.

The page memory 25 is a memory that stores image data to be processed. For example, the page memory 25 stores color image data for one page. The page memory 25 is controlled by a not-shown page memory control unit. In the configuration example shown in FIG. 2, the page memory 25 stores image data as a result of the processing by the input image processing unit 24.

The output image processing unit 26 processes an output image. In the configuration example shown in FIG. 2, the output image processing unit 26 functions as a printer-system image processing unit that generates image data to be printed on a sheet by the printer 12. For example, the output image processing unit 26 converts the image data stored in the page memory 25 into image data for printing. Various kinds of image processing by the output image processing unit 26 may be realized by the CPU 21 executing a program for image processing.

The input image processing unit 24 includes an outside-of-document erasing unit 31 and various image processing modules 32a, 32b, and 32c.

The outside-of-document erasing unit 31 erases an image area other than an original document image in image data (converts the image area into a white image). In the configuration example shown in FIG. 2, the outside-of-document erasing unit 31 detects an area on the outside of an original document in image data scanned by the scanner 11 and outputs the image data from which the detected area on the outside of the original document is erased. A configuration and operations of the outside-of-document erasing unit 31 are explained in detail later.

The image processing modules 32a, 32b, and 32c function as image converting units corresponding to various operation modes in the digital multifunction peripheral 1. The image processing modules 32a, 32b, and 32c process (convert) input image data according to processing contents corresponding to the operation modes, respectively. For example, the image processing module for copying 32a is an image converting unit corresponding to a copy mode as an operation mode of the digital multifunction peripheral 1. The image processing module for NW 32b is an image converting unit corresponding to a network scan mode as an operation mode of the digital multifunction peripheral 1. The image processing module for FAX 32c is an image converting unit corresponding to a facsimile mode as an operation mode of the digital multifunction peripheral 1.

In the first configuration example shown in FIG. 2, when the digital multifunction peripheral 1 is in the copy mode, in the input image processing unit 24, the image processing module for copying 32a converts image data supplied from the outside-of-document erasing unit 31 into image data for copying (for printing). When the digital multifunction peripheral 1 is in the network scan mode, in the input image processing unit 24, the image processing module for NW 32b converts image data supplied from the outside-of-document erasing unit 31 into image data for a network (image data as a scan result to be transmitted to an external apparatus via the network). When the digital multifunction peripheral 1 is in the facsimile mode, in the input image processing unit 24, the image processing module for FAX 32c converts image data supplied from the outside-of-document erasing unit 31 into image data for facsimile transmission (facsimile data to be transmitted to an external apparatus via a facsimile line).

The image processing module for copying 32a has image processing functions such as shading correction, gradation conversion, inter-line correction, color conversion, and compression. The shading correction is processing for correcting image data according to sensitivity fluctuation in respective photoelectric conversion elements in the scanner 11 or a light distribution characteristic of a lamp (not shown) for illuminating an original document. The gradation conversion is processing for converting values of respective pixels forming image data (e.g., values of R, G, and B signals) according to a not-shown lookup table (LUT). The inter-line correction is processing for correction physical positional deviation of respective CCD sensors for R, G, and B in the scanner 11. The color conversion is processing for converting image data formed by R, G, and B pixel signals into image data formed by C, M, and Y pixel signals (image data for printing). Filtering, gamma correction, gradation correction, or the like may be performed as processing corresponding to a characteristic of a printer together with the color conversion. The compression is processing for encoding image data.

The outside-of-original erasing processing in the outside-of-original erasing unit 31 is explained in detail below.

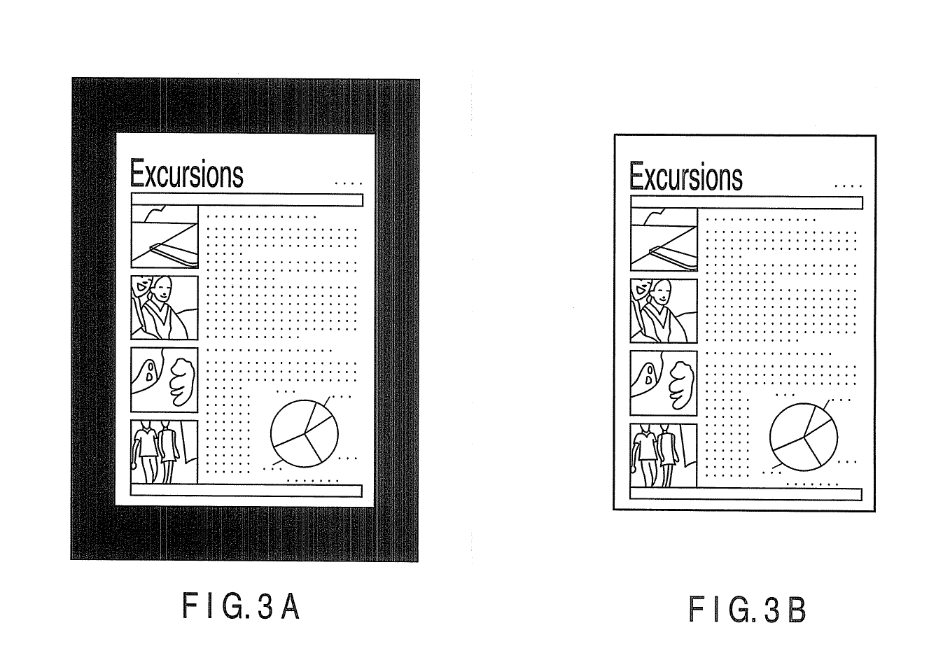

FIG. 3A is a diagram of an example of an image obtained by scanning an original document set on the glass table 11a in a state in which the document cover 11b is opened. FIG. 3B is a diagram of an image obtained by erasing a black image on the outside of the original document from the scanned image shown in FIG. 3A. In the image shown in FIG. 3B, only the black image on the outside of the original document is erased. Conversion of the image shown in FIG. 3A into the image shown in FIG. 3B is the outside-of-document erasing processing.

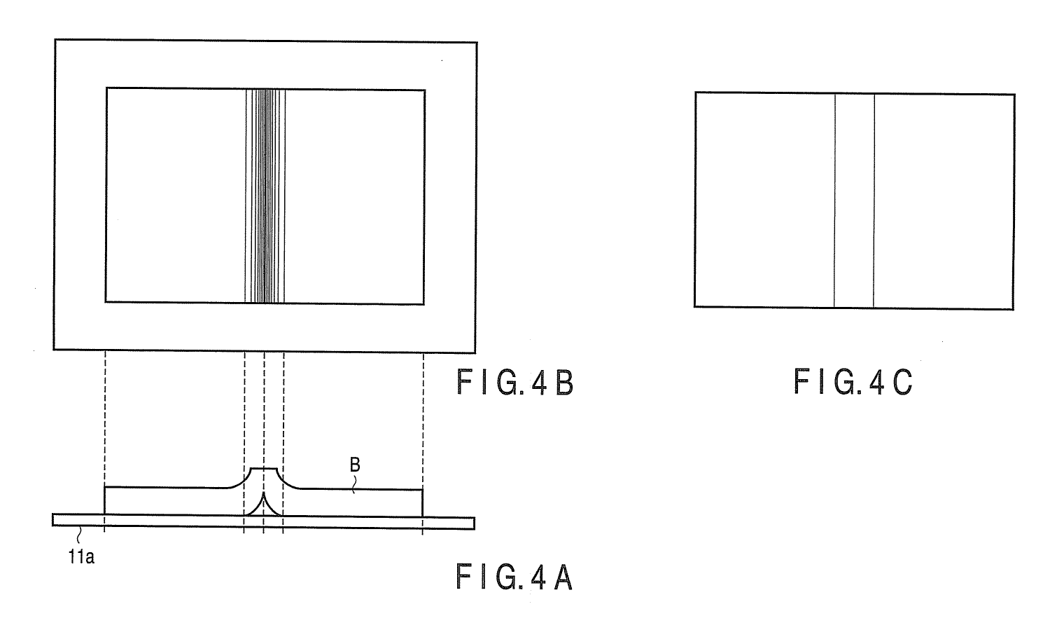

FIG. 4A is a diagram of a spread book B placed on the glass table 11a in a state in which the document cover 11b is opened. FIG. 4B is a diagram of an example of an image obtained by scanning the spread book B placed on the glass table 11a as shown in FIG. 4A. The image shown in FIG. 4B includes a black image area on the outside of an original document and an area of an original document image. Further, the image shown in FIG. 4B includes an area of pixels close to black (having high density values) (hereinafter also referred to as high-density area in the center) near a center line with respect to the left to right direction (an area including a boundary of spread two pages). In general, the high-density area in the center in the scanned image shown in FIG. 4B is densest in the center line as the boundary and becomes thinner away from the center line. This is because, when a spread book is placed on the glass table 11a, usually, a center line (a boundary of pages) portion of the book is farthest away (lifted) from the glass table 11a.

FIG. 4C is a diagram of an example of an image obtained by applying the outside-of-document erasing processing to the image data shown in FIG. 4B. The image shown in FIG. 4C is an image obtained by erasing an area formed by pixels having density values equal to or higher than a density value as a determination criterion from the image data shown in FIG. 4B. In the image shown in FIG. 4C, the black image area on the outside of the original document and the high-density area in the center in the original document image shown in FIG. 4B are erased. A density value of the high-density area in the center is not fixed. In the outside-of-document erasing processing for the high-density area in the center, if a reference value (intensity) for determining that an area is on the outside of the original document fluctuates, an area determined as the outside of the original document also changes. Therefore, in the digital multifunction peripheral 1, it is difficult to unconditionally set a level (intensity) for determining an area on the outside of the original document. Therefore, in the digital multifunction peripheral 1, the reference value indicating the level (intensity) for determining an area as an area on the outside of the original document is adjusted (set) according to an instruction by the user.

A configuration of the outside-of-document erasing unit 31 is explained below.

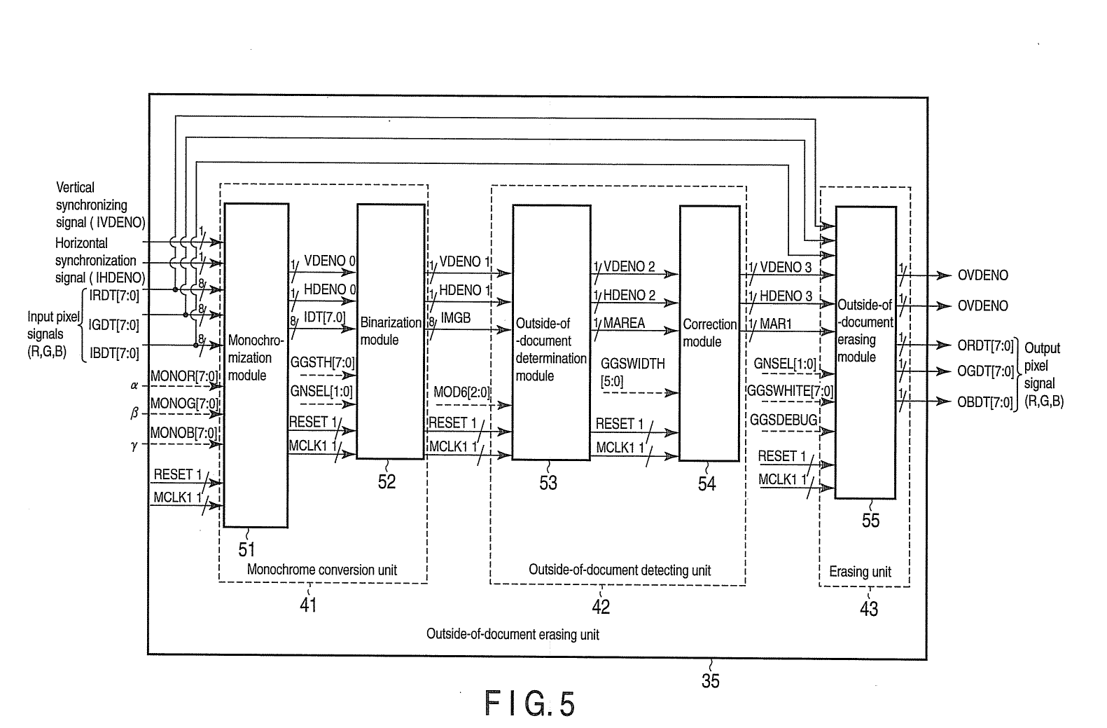

FIG. 5 is a diagram of a configuration example of the outside-of-document erasing unit 31.

In the configuration example shown in FIG. 5, the outside-of-document erasing unit 31 has a monochrome conversion unit 41, an outside-of-document detecting unit 42, and an erasing unit 43.

The monochrome conversion unit 41 converts an input image into a binary monochrome image data. The monochrome conversion unit 41 includes a monochromization module 51 and a binarization module 52. The monochromization module 51 is a module that monochromizes input image data. When color image data formed by pixels having values (R, G, B) of R, G, and B signals is supplied from the scanner 11, the monochromization module 51 monochromizes respective color pixels forming the color image data. For example, the monochromization module 51 converts color pixels having R, G, and B pixels values into a monochromized pixel value (BK) according to Formula (A1).

BK=α×R+β×G+γ×B (A1)

α, β, and γ in Formula (A1) are coefficients satisfying a condition (B1) “0≦α, β, γ≦1 (B1)”. For example, it is conceivable that the monochromization module 51 calculates the monochrome pixel value (BK) from the color pixel values according to BK=(R+G+B)/3. In this case, each of the coefficients α, β, and γ is “0.333 . . . ”. The coefficients α, β, and γ are desirably values that make it easy to separate a black image in an original document (hereinafter also referred to as black image in the inside of the original document) and a black image as an image on the outside of the original document in a document cover open state (hereinafter also referred to as black image on the outside of the original document).

The black image on the outside of the original document indicates a state in which reflected light from the original document is not made incident on a CCD sensor. Therefore, it is expected that, in the black image on the outside of the original document, all the R, G, and B signals of the respective color pixels have values close to a maximum density value. On the other hand, it is expected that, in the black image in the original document, the R, G, and B signals of the respective color pixels have a tendency corresponding to a characteristic of the entire original document. In order to highly accurately separate the black image on the outside of the original document and the other images, it is desirable to set the coefficients α, β, and γ corresponding to such a characteristic.

For example, when a density value of the R signal tends to be large in the black image in the original document, if a value of the coefficient α is set to a relatively small value compared with the coefficients β and γ, a BK value in the black image in the original document has a density value smaller than a simple average of the R, G, and B signals. As a result, it is easy to separate the black image in the original document and the black image on the outside of the original document.

The binarization module 52 binarizes the pixels monochromized by the monochromization module 51. The binarization module 52 binarizes a BK value according to a threshold (a reference value given from the CPU) for separating the black image on the outside of the original document and the images in the other areas. For example, the binarization module 52 converts pixels having BK values equal to or larger than the threshold into “1” and converts pixels having BK values smaller than the threshold into “0”. In this case, the binarization module 52 discriminates that the pixels having the BK values equal to or larger than the threshold are likely to be the black image on the outside of the original document and discriminates that the pixels having the BK values smaller than the threshold is likely to be other than the black image on the outside of the original document.

The outside-of-document detecting unit 42 determines whether pixels are the pixels from the image on the outside of the original document. The outside-of-document detecting unit 42 includes an outside-of-document determination module 53 and a correction module 54.

The outside-of-document determination module 53 determines whether the pixels are the pixels on the outside of the original documents according to pixel values binarized by the binarization module 52. For example, in the example explained above, the pixels having the binarized value “1” are the pixels on the outside of the original document and the pixels having the binarized value “0” are the pixels other than those on the outside of the original document (the pixels in the original document). In this case, the outside-of-document determination module 53 determines that the pixels having the binarized value “1” are on the outside of the original document and the pixels having the binarized value “0” are in the original document. However, the black image on the outside of the original document is considered to be distributed around the image in the original document. Therefore, the correction module 54 may determine whether positions where the pixels are present (an area where the pixels are present) are also likely to be on the outside of the original document. For example, if all adjacent pixels are the pixels in the original document, the correction module 54 corrects a determination result to determine even the pixels having the binarized value “1” are determined as being in the original document.

The erasing unit 43 erases the area determined as the outside of the original document. The erasing unit 43 includes an outside-of-document erasing module 55. The outside-of-document erasing module 55 erases an image of the area determined as the outside of the original document by the outside-of-document detecting unit 42. In other words, information indicating the area on the outside of the original document in the input image detected by the outside-of-document detecting unit 42 is given to the outside-of-document erasing module 55. The input image data (the color image data scanned by the scanner 11) itself is also supplied to the outside-of-document erasing module 55. The outside-of-document erasing module 55 erases the image of the area on the outside of the original document in the color image data as the input image according to the information indicating the area on the outside of the original document given from the outside-of-document detecting unit 42. The outside-of-document erasing module 55 outputs, as a processing result, the color image data from which the image of the area on the outside of the original document is erased.

A flow of signals in the outside-of-original erasing unit 31 is explained in detail below.

The modules 51 to 55 in the outside-of-original erasing unit 31 have input and output signals shown in FIG. 5. As shown in FIG. 5, the modules 51 to 55 in the outside-of-document erasing unit 31 operate according to a reset signal (RESET) and a main clock signal (MCLK1) from the CPU 21.

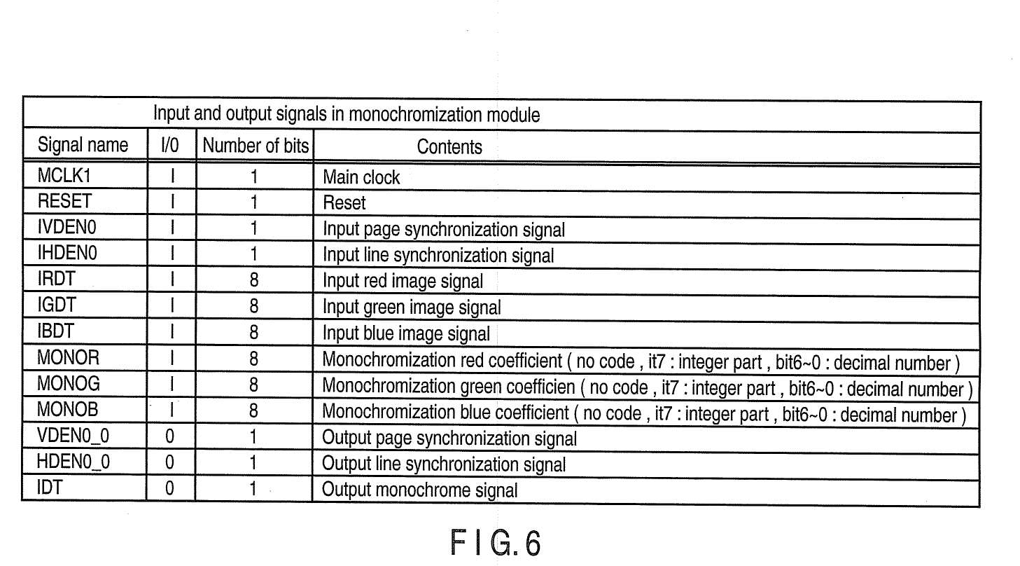

FIG. 6 is a diagram of contents of input and output signals in the monochromization module 51. As shown in FIG. 6, input pixel signals (IRDT, IGDT, and IBDT) are input to the monochromization module 51 together with a vertical synchronization signal (IVDEN) and a horizontal synchronization signal (IHDEN). The input pixel signals (IRDT, IGDT, and IBDT) are R, G, and B signal of color pixels in a color image such as a scanned image by the scanner 11. The input pixel signals are supplied to the monochromization module 51 and the outside-of-original erasing module 55 in the outside-of-original erasing unit 31.

Input pixels signals (IRDT, IGDT, and IBDT) indicating R, G, and B signals of color pixels forming input image data are input to the monochromization module 51 together with a vertical synchronization signal (IVDEN0) and a horizontal synchronization signal (IHDEN0). The CPU 21 supplies values (MONOR, MONOG, and MONOB) of the coefficients α, β, and γ for monochromizing three signals of R, G, and B to the monochromization module 51.

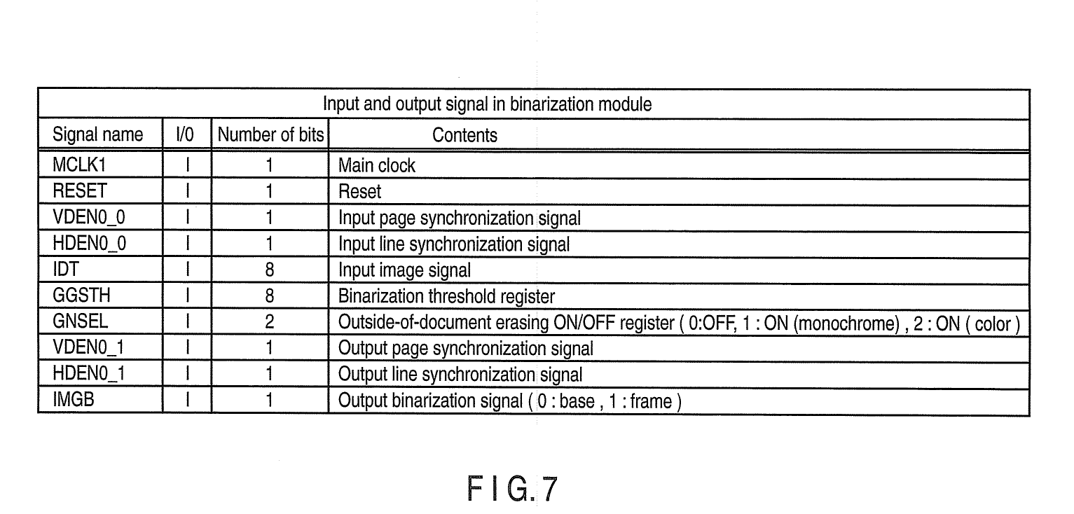

The monochromization module 51 multiplies the three signals (IRDT, IGDT, and IBDT) as the input pixel signals with the coefficients α, β, and γ, respectively, and calculates a total value of the multiplied values. This calculated total value is a BK value (IDT) as a monochrome pixel value obtained by monochromizing the input pixel signals. As shown in FIG. 7, the monochromization module 51 outputs the calculated BK value (IDT) to the binarization module 52 in synchronization with timing of a vertical synchronization signal (IVDEN0_0) and a horizontal synchronization signal (IHDEN0_0).

FIG. 7 is a diagram of contents of input and output signals in the binarization module 52. The binarization module 52 binarizes the BK value (IDT) supplied from the monochromization module 51. The CPU 21 supplies a threshold (GGSTH) for binarizing the BK value (IDT) to the binarization module 52. The binarization module 52 determines whether the BK value (IDT) is equal to or larger than the threshold (GGSTH). For example, the binarization module 52 converts a BK value equal to or larger than the threshold into “1” and converts a BK value smaller than the threshold into “0”. In other words, the binarization module 52 converts pixels of an input color image into a binarized pixel value (IMGB). The binarization module 52 outputs the binarized pixel value (IMGB) to the outside-of-document determination module 53 in synchronization with a vertical synchronization signal (IVDEN0_1) and a horizontal synchronization signal (IHDEN0_1).

The binarized pixel value (IMGB) is input to the outside-of-document determination module 53 together with a vertical synchronization signal (IVDEN0) and a horizontal synchronization signal (IHDEN0). The binarization module 52 converts pixels equal to or larger than the threshold into “1” and converts pixels smaller than the threshold into “0”. In this case, the outside-of-document determination module 53 determines that pixels having the binarized pixel value (IMGB) “1” is on the outside of the original document and pixels having the binarized pixel value (IMGB) “0” is in the original document. The outside-of-document determination module 53 supplies information (MAREA) indicating a determination result based on the binarized pixel value (IMGB) to the correction module 54 at timing indicated by a vertical synchronization signal (IVDEN0_2) and a horizontal synchronization signal (IHDEN0_2). The information (MAREA) indicating the determination result is, for example, information indicating positions of the pixels determined as an area on the outside of the original document.

The information (MAREA) indicating the determination result based on the binarized pixel value is supplied to the correction module 54 in synchronization with the vertical synchronization signal (IVDEN0_2) and the horizontal synchronization signal (IHDEN0_2). The correction module 54 corrects the information (MAREA) indicating the determination result. For example, the correction module 54 checks whether the positions of the pixels determined as being on the outside of the original document are an area on the outside of the original document.

When the correction module 54 determines that the determination result (MAREA) by the outside-of-original determination module 53 is positionally likely, the correction module 54 outputs the information (MAREA) indicating the determination result to the outside-of-document erasing module 55 as a final determination result (MAR1). When the correction module 54 determines that the determination result (MAREA) by the outside-of-document determination module 53 is positionally unlikely, the correction module 54 outputs a determination result obtained by correcting the information (MAREA) indicating the determination result to the outside-of-document erasing module 55 as the information (MAR1) indicating a final determination result.

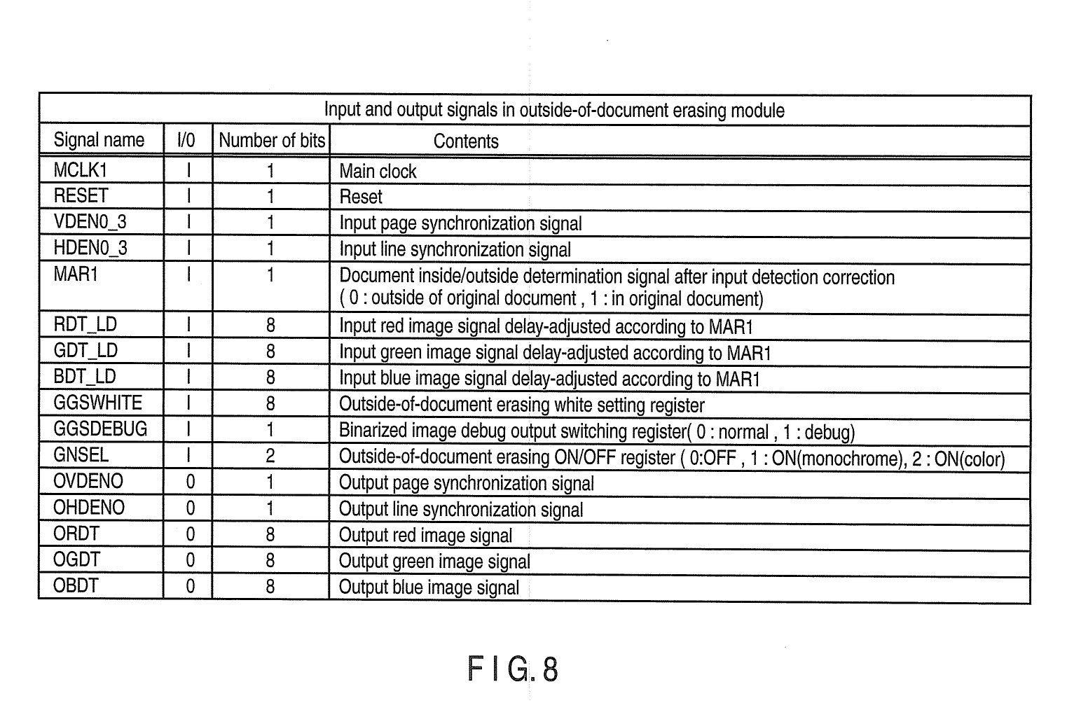

FIG. 8 is a diagram of contents of input and output signals in the outside-of-document erasing module 55. As shown in FIG. 8, the information (MAR1) indicating final results for respective pixels is supplied to the outside-of-document erasing module 55 in synchronization with a vertical synchronization signal (IVDEN0_3) and a horizontal synchronization signal (IHDEN0_3). Further, input pixel signals (IRDT, IGDT, and IBDT) as pixel data forming an input image (color image data) supplied to the outside-of-document erasing unit 31 are also supplied to the outside-of-document erasing module 55.

Therefore, the information (MAR1) indicating whether the pixels are on the outside of the original document is supplied to the outside-of-document erasing module 55 together with the input pixel signals (IRDT, IGDT, and IBDT). The input pixel signals (IRDT, IGDT, and IBDT) supplied to the outside-of-document erasing module 55 and the information (MAR1) indicating a determination result correspond to each other. For example, the input pixel signals (IRDT, IGDT, and IBDT) are delayed by a not-shown delay circuit and input to the outside-of-document erasing module 55 to correspond to the information (MAR1) indicating a determination result of the pixels.

The outside-of-document erasing module 55 outputs, as output pixel signals (ORDT, OGDT, and OBDT), image data from which the area on the outside of the original document is erased. In other words, when the information (MAR1) indicating a determination result indicates that the pixels are not pixels on the outside of the original document, the outside-of-document erasing module 55 directly outputs the input pixel signals (IRDT, IGDT, and IBDT) as the output pixel signals (ORDT, OGDT, and OBDT). When the information (MAR1) indicating a determination result indicates that the pixels are pixels on the outside of the original document, the outside-of-document erasing module 55 outputs a pixel value (a pixel value of white), with which all the R, G, and B signals have minimum density values, as the output pixel signals (ORDT, OGDT, and OBDT) in order to erase the pixels (the pixels forming the black image on the outside of the original document).

A flow of processing in the digital multifunction peripheral 1 according to the first configuration example shown in FIG. 2 is explained below.

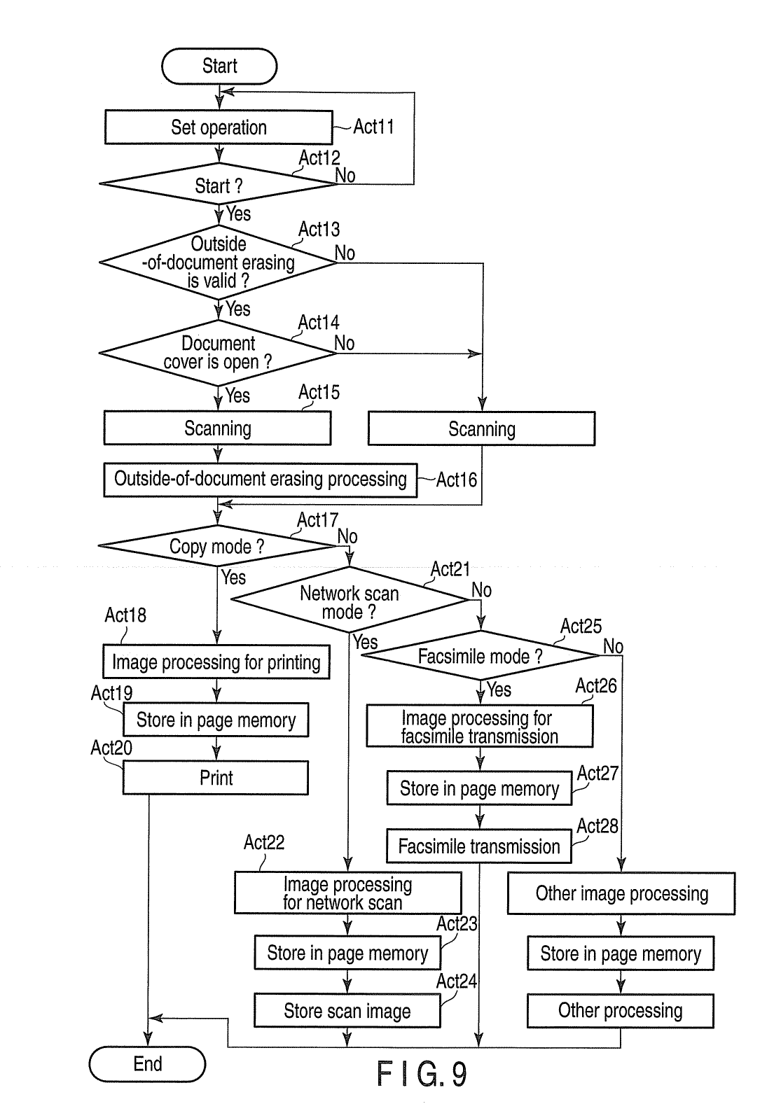

FIG. 9 is a flowchart for explaining a flow of processing including processing for scanning an original document image in the digital multifunction peripheral 1 according to the first configuration example.

First, it is assumed that the digital multifunction peripheral 1 operates in any one operation mode among a copy mode, a network scan mode, and a facsimile mode. The outside-of-document erasing processing may be set to be valid as default or may be set to be valid only when the user designates the processing.

First, when the user performs copying, network scan, or facsimile transmission, the user sets an original document in the scanner 11. For example, the user sets the original document on the glass table 11a. After setting the original document, the user designates an operation mode using the operation unit 15. In designating an operation mode, the user can also designate whether the outside-of-document erasing processing should be set valid or invalid. The CPU 21 sets the operation mode and valid and invalid of the outside-of-document erasing processing according to the designation by the user (Act 11).

After designating the operation mode, the user enters a start key for instructing the start of scanning of the original document in the operation unit 15. When the CPU 21 detects the enter of the start key, the CPU 21 starts the scanning of the original document. When the scanning of the original document is started (Act 12, YES), the CPU 21 determines whether the outside-of-document erasing processing is valid (Act 13). The CPU 11 may check whether the outside-of-document erasing processing is valid or invalid at every predetermined interval until the start of scanning of the original document is instructed.

If the outside-of-document erasing processing is valid at the start of the scanning (Act 13, YES), the CPU 11 determines on the basis of a detection signal of the open and close detector 11c whether the document cover 11b is in the open state (Act 14). When it is determined that the document cover 11b is in the open state (Act 14, YES), the CPU 11 scans the original document on the glass table 11a using the scanner 11 (Act 15). In this case, the main control unit 10 supplies an image scanned by the scanner 11 to the outside-of-document erasing unit 31. The outside-of-document erasing unit 31 erases an image area on the outside of the original document from image data supplied from the scanner 11 (Act 16).

The CPU 21 supplies the image data from which the image area on the outside of the original document by the outside-of-document erasing unit 31 to the image processing module 32a, 32b, or 32c corresponding to the operation mode.

When the operation mode of the digital multifunction peripheral 1 is the copy mode (Act 17, YES), the CPU 21 supplies the image data (the image data from which the image area on the outside of the original document is erased) output from the outside-of-document erasing unit 31 to the image processing module for copying 32a. The image processing module for copying 32a generates, according to image processing for printing (for copying) (e.g., color conversion to C, M, and Y signals), image data for printing (for copying) from the image data from which the area on the outside of the original document is erased (Act 18). The image processing module for copying 32a stores the generated image data for printing in the page memory 25 (Act 19). When the image data for printing is stored in the page memory 25, the CPU 21 processes the image data for printing stored in the page memory 25 using the output image processing unit 26 and prints (copies) the image data on a sheet using the printer 12 (Act 20).

When the operation mode of the digital multifunction peripheral 1 is the network scan mode (Act 21, YES), the CPU 21 supplies the image data (the image data from which the image area on the outside of the original document) output from the outside-of-document erasing unit 31 to the image processing module for NW 32b. The image processing module for NW 32b generates, according to image processing for network scan (e.g., resolution conversion or image compression corresponding to user designation), image data for network scan (image data as a scan result) from the image data from the area on the outside of the original document is erased (Act 22). The image processing module for NW 32b stores the generated image data for network scan in the page memory 25 (Act 23). When the image data for network scan is stored in the page memory 25, the CPU 21 transmits, through the network interface 14, the image data for network scan stored in the page memory 25 to a destination designated by the user as a scan result (Act 24).

When the operation mode of the digital multifunction peripheral 1 is the facsimile mode (Act 25, YES), the CPU 21 supplies the output (the image data from which the image area on the outside of the original document is erased) from the outside-of-document erasing unit 31 to the image processing module for FAX 32c. The image processing module for FAX 32c generates, according to image processing for facsimile transmission (e.g., monochrome conversion), image data for facsimile transmission from the image data from which the area on the outside of the original document is erased (Act 26). The image processing module for FAX 32c stores the generated image data for facsimile transmission in the page memory 25 (Act 27). When the image data for facsimile transmission is stored in the page memory 25, the CPU 21 transmits, through the facsimile interface 13, the image data for facsimile transmission stored in the page memory 25 to a destination of a telephone number designated by the user (Act 28).

When the outside-of-document erasing processing is set invalid (Act 13, NO) or when the document cover 11b is closed (Act 14, NO), the CPU 21 omits the processing by the outside-of-document erasing unit 31 applied to the image data scanned by the scanner 11. In other words, when the outside-of-document erasing processing is unnecessary, the CPU 21 directly supplies the image data scanned by the scanner 11 to the image processing module 32a, 32b, or 32c corresponding to the operation mode. In this case, the image processing module 32a, 32b, or 32c selected according to the operation mode generates image data corresponding to the operation mode from the image data not subjected to the outside-of-document erasing processing.

As explained above, in the digital multifunction peripheral 1 according to the first configuration example, the outside-of-document erasing unit 31 is provided before the image data scanned by the scanner 11 is supplied to the image processing modules corresponding to the various operation modes. As a result, in the digital multifunction peripheral 1 according to the first configuration example, it is possible to prevent fluctuation from occurring in a result of the outside-of-document erasing processing depending on an operation mode. In other words, in the digital multifunction peripheral according to the first configuration example, it is possible to apply the same outside-of-document erasing processing to input image data irrespective of an operation mode.

A digital multifunction peripheral and a main control unit according to a second configuration example are explained below.

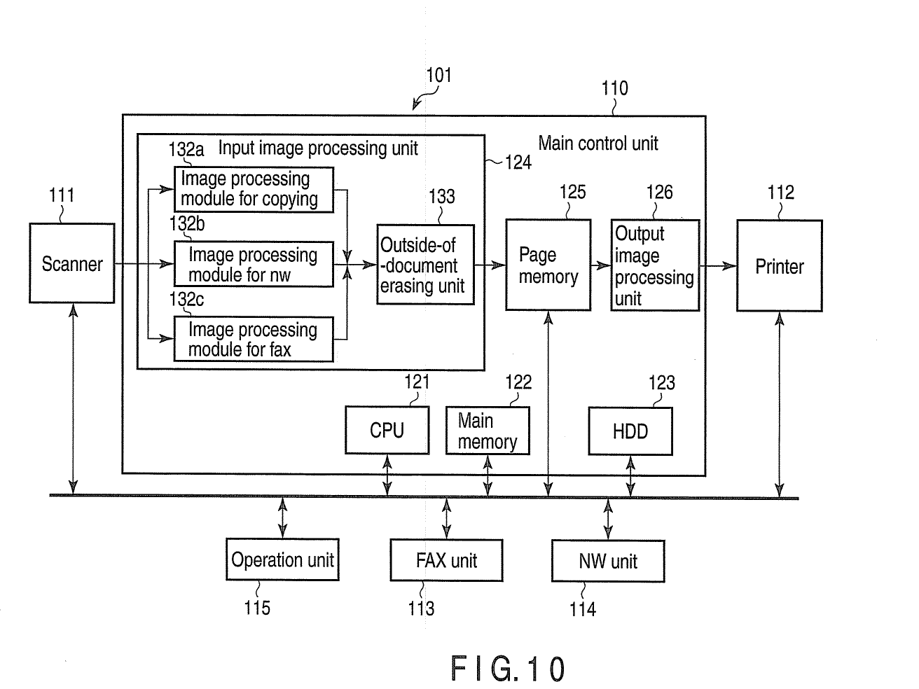

FIG. 10 is a block diagram of a digital multifunction peripheral 101 and a main control unit 110 according to the second configuration example.

As shown in FIG. 10, the digital multifunction peripheral 101 according to the second configuration example includes the main control unit 110, a scanner 111, a printer 112, a facsimile communication unit (a FAX unit) 113, a network communication unit (a NW unit) 114, and an operation unit 115. The scanner 111, the printer 112, the facsimile communication unit (the FAX unit) 113, the network communication unit (the NW unit) 114, and the operation unit 115 are the same as the scanner 11, the printer 12, the FAX unit 13, the NW unit 14, and the operation unit 15 in the digital multifunction peripheral 1 according to the first configuration example shown in FIGS. 1 and 2. Therefore, detailed explanation is omitted concerning the scanner 111, the printer 112, the FAX unit 113, the NW unit 114, and the operation unit 115.

The main control unit 110 according to the second configuration example shown in FIG. 10 has basic functions same as those of the main control unit 10 shown in FIG. 2 explained in the first configuration example. However, a flow of processing for input image data is different in the main control unit 110 according to the second configuration example and the main control unit 10 according to the first configuration example.

As shown in FIG. 10, the main control unit 110 according to the second configuration example includes a CPU 121, a main memory 122, an HDD 123, a scanner-system image processing unit (an input image processing unit) 124, a page memory 125, and a printer-system image processing unit (an output image processing unit) 126. The main memory 122, the HDD 123, the page memory 125, and the printer-system image processing unit (the output image processing unit) 126 can be realized as those same as the main memory 22, the HDD 23, the page memory 25, and the output image processing unit 26 explained in the first configuration shown in FIG. 2. Therefore, detailed explanation is omitted concerning the main memory 122, the HDD 123, the page memory 125, and the output image processing unit 126.

The CPU 121 manages control of the entire digital multifunction peripheral 101. The CPU 121 realizes various functions by executing programs stored in a not-shown program memory. Like the CPU 21 according to the first configuration example, the CPU 121 performs control for realizing a copy function, a facsimile function, and a network scan function. The CPU 121 also has a function of setting a value corresponding to an operation mode of the digital multifunction peripheral 101 as a reference value for detecting an area on the outside of an original document in the outside-of-document erasing processing.

The input image processing unit 124 processes an input image. The input image processing unit 124 shown in FIG. 10 functions as a scanner-system image processing unit that processes, as an input image, an image scanned by the scanner 111. Various kinds of image processing by the input image processing unit 124 may be realized by the CPU 121 executing programs for image processing. An image input to the input image processing unit 124 is not limited to image data input from the scanner 111. For example, the input image processing unit 124 may input, as an input image, image data received by the NW unit 114 through a network or image data received by the FAX unit 113 through facsimile communication.

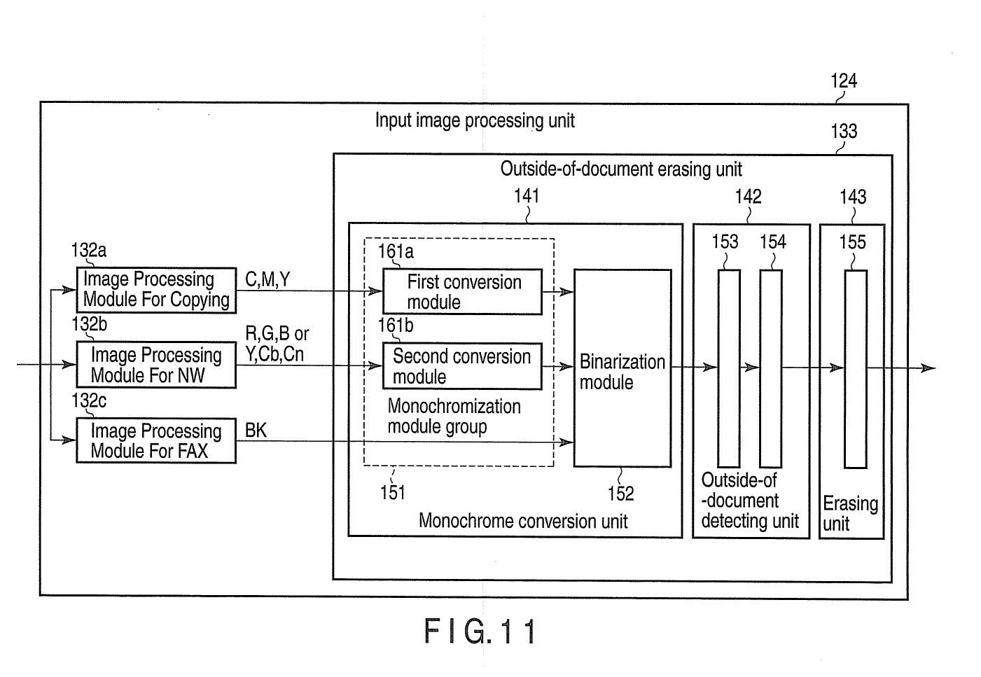

The input image processing unit 124 includes various image processing modules 132a, 132b, and 132c and an outside-of-document erasing unit 133. The input image processing unit 124 according to the second configuration example shown in FIGS. 10 and 11 is different from the input image processing unit 24 according to the first configuration example shown in FIG. 2 in order for processing image data supplied from the scanner.

The image processing modules 132a, 132b, and 132c are image converting units that convert image data according to an operation mode. The image processing module 132a, 132b, or 132c is selected according to an operation mode of the digital multifunction peripheral 101. The image processing module 132a, 132b, or 132c selected according to the operation mode subjects image data scanned by the scanner 111 to image processing and supplies the image data to the outside-of-document erasing unit 133.

Contents of the image processing executed by the image processing modules 132a, 132b, and 132c may be the same as the contents of the image processing executed by the image processing modules 32a, 32b, and 32c explained in the first configuration example. Therefore, detailed explanation is omitted concerning the contents of the image processing in the image processing modules 132a, 132b, and 132c.

The outside-of-document erasing unit 133 erases an area on the outside of an original document from image data processed by the image processing modules 132a, 132b, and 132c (converts the area into white). The outside-of-document erasing unit 133 converts the image data into binary monochrome image data, detects the area on the outside of the original document from the binary monochrome image data, and erases the area on the outside of the original document from the image data.

The outside-of-document erasing processing in the outside-of-document erasing unit 133 is explained in detail below.

FIG. 11 is a diagram of a configuration of the outside-of-document erasing unit 133 according to the second configuration example.

As shown in FIG. 11, the outside-of-document erasing unit 133 according to the second configuration example includes a monochrome conversion unit 141, an outside-of-document detecting unit 142, and an erasing unit 143. The outside-of-document detecting unit 142 and the erasing unit 143 in the outside-of-document erasing unit 133 shown in FIG. 11 can be realized as those same as the outside-of-document detecting unit 42 and the erasing unit 43 shown in FIG. 5. Therefore, detailed explanation is omitted concerning the outside-of-document detecting unit 142 and the erasing unit 143 shown in FIG. 11.

The monochrome conversion unit 141 includes a monochromization module group 151 and a binarization module 152. In an example shown in FIG. 11, the monochromization module group 151 includes a first conversion module 161a and a second conversion module 161b as modules for monochromizing image data.

In the example shown in FIG. 11, the image processing module for copying 132a outputs, as color image data for printing, color image data of a complementary color system formed by signals of C (cyan), M (magenta), and Y (yellow). The image processing module for NW 132b outputs, as color image data as a scan result, color image data of a primary color system formed by signals of R (red), G (green), and B (blue). The image processing module for NW 132b may output color image data formed by signals of Y, Cb, and Cn as the color image data as a scan result. Further, the image processing module for NW 132b may output color image data of a data format (a data format such as JPEG) designated by the user as the color image data as a scan result. The image processing module for FAX 132c outputs monochrome image data formed by a signal of BK (monochrome) as image data for facsimile transmission.

The monochromization module group 151 shown in FIG. 11 includes conversion modules for monochrome conversion corresponding to the image processing modules 132a, 132b, and 132c. The first conversion module 161a is a processing module for monochrome conversion corresponding to the image processing module for copying 132a. The second conversion module 161b is a processing module for monochrome conversion corresponding to the image processing module for NW 132b.

As shown in FIG. 11, when the image processing module for FAX 132c outputs monochrome image data, a module for monochrome conversion corresponding to the image processing module for FAX 132c is unnecessary. However, a processing module that corrects the monochrome image data from the image processing module for FAX 132c before the monochrome image data is supplied to the binarization module may be provided in the monochromization module group 151.

The first conversion module 161a corresponding to the image processing module for copying 132a supplies image data obtained by monochromizing color image data given from the image processing module for copying 132a to the binarization module. When the image processing module for copying 132a outputs color image data including color pixels formed by signals of C, M, Y, the first conversion module 161a converts the color pixels formed by values of C, M, and Y into monochrome pixels. In this case, a method same as the processing for monochromizing the color pixels formed by the values of R, G, and B can be applied to the first conversion module 161a. The first conversion module 161a converts the color pixels formed by the values of C, M, and Y into a monochrome pixel value (BK) according to “BK=α×C+β×M+γ×Y” using α, β, and γ that satisfy “0≦α, β, γ≦1, α+β+γ”.

For example, in the first conversion module 161a, it is conceivable to calculate the monochrome pixel value (BK) from a color pixel value according to BK=(C+M+Y)/3. In this case, each of the coefficients α, β, and γ is set as “0.333 . . . ”. The CPU 121 sets the coefficients α, β, and γ in the first conversion module 161a. The coefficients α, β, and γ are desirably values that make it easy to separate a black image in an original document image and a black image on the outside of the original document image. For example, the CPU 121 determines values of the coefficients α, β, and γ on the basis of original document modes (e.g., a character mode, a photograph mode, and a character and photograph mode).

The second conversion module 161b corresponding to the image processing module for NW 132b supplies image data obtained by monochromizing color image data obtained as a scan result to the binarization module 152. The second conversion module 161b converts color image data given as a scan result from the image processing module for NW 132b into monochrome image data. For example, the second conversion module 161b converts color pixels formed by value of R, G, and B or values of Y, Cb, and Cn into monochrome pixels. The monochromization processing explained above can also be applied to the second conversion module 161b.

As image processing for facsimile transmission, the image processing module for FAX 132c converts input image data into monochrome image data for facsimile transmission. Since image data output from the image processing module for FAX 132c is monochrome image data, the monochromization processing is unnecessary. Therefore, the image processing module for FAX 132c directly supplies monochrome image data as an image processing result to the binarization module 152 through the monochromization module group 151.

The binarization module 152 binarizes the monochrome image data on the basis of a reference value given from the CPU 121. Like the binarization module 52 explained in the first configuration example, the binarization module 152 binarizes pixels forming the monochrome image data according to a binarization threshold (the reference value given from the CPU 121) for separating a black image on the outside of an original image and images in the other areas.

In the second configuration example, the monochrome image data supplied to the binarization module 152 is obtained by different various kinds of processing corresponding to the operation modes. Therefore, the CPU 121 determines a binarization threshold as a reference value for detecting the outside of the original document according to an operation mode. The CPU 121 determines a binarization threshold with which areas erased by the outside-of-document erasing processing are the same as much as possible irrespective of an operation mode. In other words, the CPU 121 determines a binarization threshold corresponding to processing contents until an input image (a scan image) reaches the binarization module 152 (processing contents specified by an operation mode) such that the same area is erased as the outside of the original document irrespective of an operation mode. After determining such a binarization threshold, the CPU 121 sets the binarization threshold in the binarization module 152.

For example, when the digital multifunction peripheral 101 is in the copy mode, the CPU 121 supplies a binarization threshold for the copy mode to the binarization module 152. In the copy mode, image data scanned by the scanner 111 is subjected to image processing by the image processing module for copying 132a and monochromized by the first conversion module 161a. In other words, when the digital multifunction peripheral 101 is in the copy mode, the CPU 121 sets, in the binarization module 152, a binarization threshold for the copy mode corresponding to processing contents of the image processing module for copying 132a and the first conversion module 161a.

When the digital multifunction peripheral 101 is in the network scan mode, the CPU 121 supplies a binarization threshold for the network scan mode to the binarization module 152. In the network scan mode, image data scanned by the scanner 111 is subjected to image processing by the image processing module for NW 132b and monochromized by the second conversion module 161b. When the digital multifunction peripheral 101 is in the network scan mode, the CPU 121 sets, in the binarization module 152, a binarization threshold for the network scan mode corresponding to processing contents of the image processing module for NW 132b and the second conversion module 161b.

When the digital multifunction peripheral 101 is in the facsimile mode, the CPU 121 supplies a binarization threshold for the facsimile mode to the binarization module 152. In the facsimile mode, image data scanned by the scanner 111 is monochromized by the image processing module for FAX 132c as monochrome image data for facsimile transmission. In other words, when the digital multifunction peripheral 101 is in the facsimile mode, the CPU 121 sets, in the binarization module 152, a binarization threshold for the facsimile mode corresponding to processing contents of the image processing module for FAX 132c.

The binarization threshold for the copy mode, the binarization threshold for the network scan mode, and the binarization threshold for the facsimile mode are set such that an area erased by the outside-of-document erasing processing is the same in all the operation modes, i.e., the copy mode, the network scan mode, and the facsimile mode. The binarization thresholds for the respective operation modes are, for example, values set in advance. The binarization thresholds for the respective operation modes may be set according to original document modes (a character mode, a photograph mode, and a character and photograph mode). Further, the binarization thresholds for the respective operation modes may be set for each of plural adjustment levels.

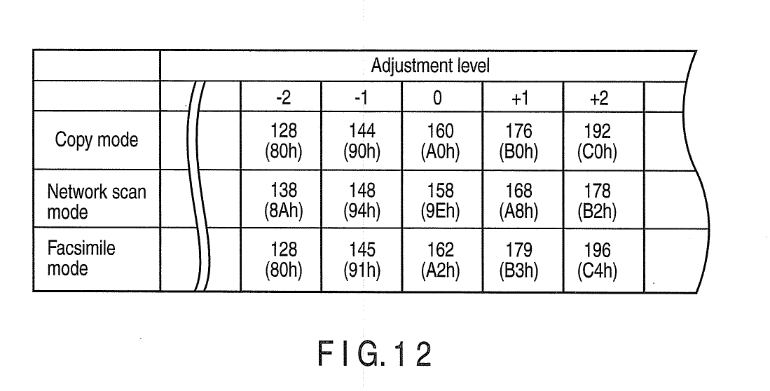

FIG. 12 is a diagram of a setting example of the binarization thresholds for the respective operation modes in the second configuration example.

In an example shown in FIG. 12, the binarization thresholds for the respective operation modes for each of plural adjustment levels. The adjustment level indicates intensity (an adjustment level) for detecting an area on the outside of an original document from image data. In the example shown in FIG. 12, it is assumed that a density value of monochrome pixels is represented by 256 gradations. Setting data of the binarization thresholds shown in FIG. 12 are stored in, for example, the HDD 23 or a not-shown nonvolatile memory.

As shown in FIG. 12, the binarization thresholds for the respective operation modes are set to different values even at the same adjustment level. This is because, as explained above, the same area is detected as an area on the outside of an original document from image data obtained by different processing for each of the operation modes. For example, in the example shown in FIG. 12, at an adjustment level “0” (a default value peculiar to the digital multifunction peripheral 101), the binarization threshold for the copy mode is larger than the binarization threshold for the network scan mode and is smaller than the binarization threshold for the facsimile mode. The binarization module 152 generates, according to the binarization threshold for each of the operation modes shown in FIG. 12, binary monochrome image data with which the same area is detected as an area on the outside of an original document at the respective adjustment levels irrespective of an operation mode.

A flow of processing in the digital multifunction peripheral 101 according to the second configuration example is explained.

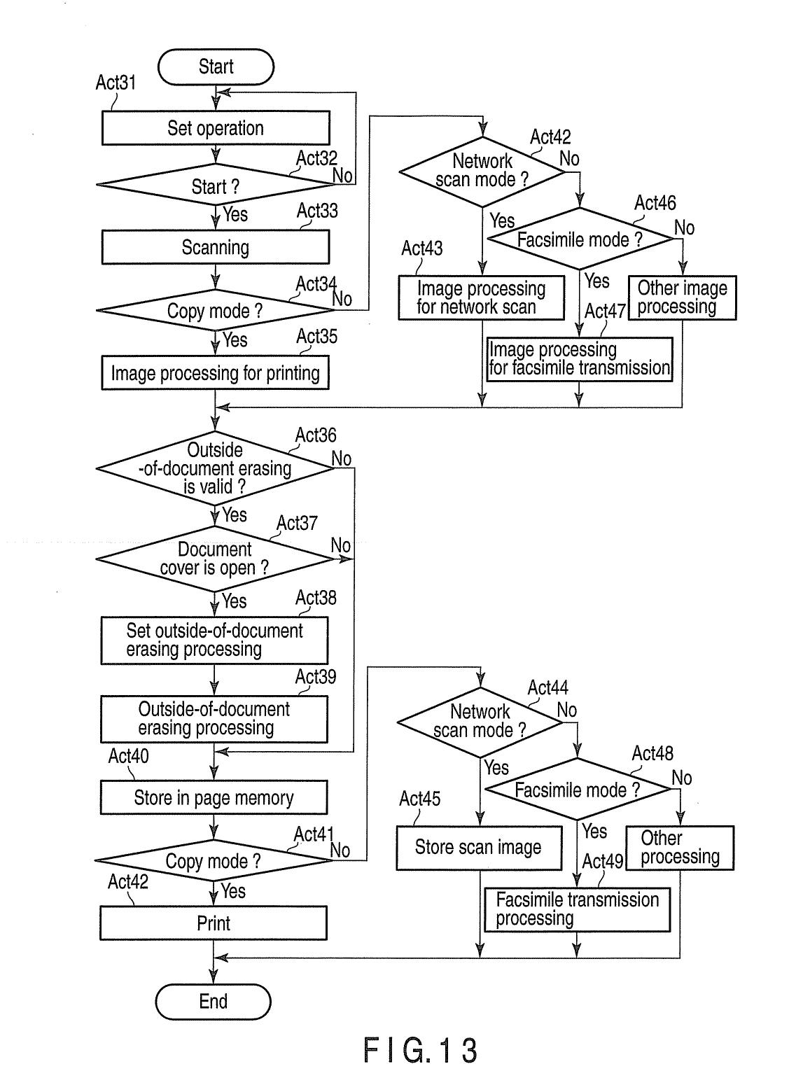

FIG. 13 is a flowchart for explaining a flow of processing including processing for scanning an original document image in the digital multifunction peripheral 101 according to the second configuration example.

In the digital multifunction peripheral 101, when the user performs copying, network scan, or facsimile transmission, the user sets an original document in the scanner 111 and designates an operation mode using the operation unit 115. In designating an operation mode, the user can designate whether the outside-of-document erasing processing should be set valid or invalid. The CPU 121 sets the operation mode according to the designation by the user (Act 31). After designating the operation mode, the user enters a start key for instructing the start of scanning of the original document provided in the operation unit 115. When the CPU 21 detects the enter of the start key (Act 32 YES), the CPU 21 starts the scanning of the original document (Act 33).

When the operation mode of the digital multifunction peripheral 101 is the copy mode (Act 34, YES), the CPU 121 supplies image data scanned by the scanner 111 to the image processing module for copying 132a. The image processing module for copying 132a applies image processing for printing (for copying) (e.g., color conversion to C, M, and Y signals) to the image data supplied from the scanner 111 (Act 35). As a result, the image processing module for copying 132a generates image data for printing from the image data scanned by the scanner 111.

On the other hand, the CPU 121 determines whether the outside-of-document erasing processing is valid (Act 36). When the outside-of-document erasing processing is valid (Act 36, YES), the CPU 121 determines on the basis of a detection signal of the detector 11c whether the document cover 11b is in the open state (Act 37). When it is determined that the document cover 11b is in the open state (Act 37, YES), the CPU 121 determines that the outside-of-document erasing processing is executed.

In executing the outside-of-document erasing processing, the CPU 121 performs setting for the outside-of-document erasing unit 133 (Act 38). In the digital multifunction peripheral 101 according to the second configuration example, as explained above, as the setting for the outside-of-document erasing unit 133, the CPU 121 selects a conversion module from the monochromization module group 151 according to an operation mode and sets a binarization threshold corresponding to the operation mode in the binarization module. When the operation mode is the copy mode, the CPU 121 selects the first conversion module 161a from the monochromization module group 151 and sets a binarization threshold for the copy mode in the binarization module 152.

The outside-of-document erasing unit 133 set by the CPU 121 according to the operation mode erases an area on the outside of the original document from the image data for printing supplied from the image processing module for copying 132a (Act 39). As explained above, the outside-of-document erasing unit 133 monochromizes the image data for printing, detects the area on the outside of the original document from the monochromized image data, and outputs the image data for printing from which the detected area on the outside of the original image is erased.

The image data, from which the area on the outside of the original document is erased, output from the outside-of-document erasing unit 113 is stored in the page memory 125 as a processing result of the input image processing unit 124. The page memory 125 stores the image data (the image data from which the area on the outside of the original document is erased) output by the outside-of-document erasing unit 133 (Act 40).

When the image data output from the input image processing unit 124 is stored in the page memory 125, the CPU 121 processes the image data stored in the page memory 125 using a processing unit (e.g., a printer, a network interface, or a facsimile interface) corresponding to the operation mode. When the operation mode is the copy mode (Act 41, YES), the CPU 121 processes the image data stored in the page memory 125 using the output image processing unit 126 and prints the image data using the printer 112 (Act 42).

When the operation mode of the digital multifunction peripheral 101 is the network scan mode (Act 43, YES), the CPU 121 supplies the image data scanned by the scanner 111 to the image processing module for NW 132b. The image processing module for NW 132b applies image processing for network scan (for network transfer) (e.g., resolution conversion or image compression corresponding to user designation) to the image data supplied from the scanner 111 (Act 44). As a result, the image processing module for NW 132b generates image data for network scan from the image data scanned by the scanner 111.

On the other hand, as explained above, the CPU 121 determines whether the outside-of-document erasing processing should be executed (Acts 36 and 37). When it is determined that the outside-of-document erasing processing is executed in the network scan mode, the CPU 121 sets the outside-of-document erasing unit 133 according to the network scan (Act 38). For example, as the setting for the network scan, the CPU 121 selects the second conversion module 161b from the monochromization module group 151 and sets a binarization threshold for the network scan mode in the binarization module 152. The outside-of-document erasing unit 133 set for the network scan erases the area on the outside of the original document from the image data for network scan supplied from the image processing module for NW 132b (Act 39) and stores the image data from which the area on the outside of the original document in the page memory 125 (Act 40).

When the operation mode is the network scan mode (Act 45, YES), the CPU 121 transfers the image data (the image data as a scan result from which the area on the outside of the original document is erased) stored in the page memory 125 to a storage destination designated by the user or stores the image data (Act 46). For example, when the image data is stored in a user terminal as an external apparatus on a network, the network interface 114 transfers the image data stored in the page memory 125 to the user terminal.

When the operation mode of the digital multifunction peripheral 101 is the facsimile mode (Act 47, YES), the CPU 121 supplies the image data scanned by the scanner 111 to the image processing module for FAX 132c. The image processing module for FAX 132c applies image processing for facsimile (facsimile transmission) (e.g., monochrome conversion) to the image data supplied from the scanner 111 (Act 48). As a result, the image processing module for FAX 132c generates image data for facsimile from the image data scanned by the scanner 111.

On the other hand, as explained above, the CPU 121 determines whether the outside-of-document erasing processing should be executed (Acts 36 and 37). When it is determined that the outside-of-document erasing processing is executed in the facsimile mode, the CPU 121 sets the outside-of-document erasing unit 133 according to the facsimile mode (Act 38). For example, as the setting for the facsimile mode, the CPU 121 omits the respective conversion modules of the monochromization module group 151 and sets a binary threshold for the facsimile mode in the binarization module 152. The outside-of-document erasing unit 133 set for the facsimile mode erases the area on the outside of the original document from the image data for facsimile supplied from the image processing module for FAX 132c (Act 39) and stores the image data from which the area on the outside of the original document is erased in the page memory 125 (Act 40).

When the operation mode is the facsimile mode (Act 49, YES), the CPU 121 transmits by facsimile the image data stored in the page memory 125 (image data for facsimile transmission from which the area on the outside of the original document is erased) to a telephone number designated by the user (Act 50).

As explained above, in the digital multifunction peripheral according to the second configuration example, the image data scanned by the scanner is processed by the image processing units corresponding to the various operation modes and the area on the outside of the original document is erased from the image data, which is processed by the respective image processing units, by the outside-of-document erasing unit set according to the operation modes. The outside-of-document erasing unit is set according to the operation modes (processing contents of the image processing units corresponding to the operation modes) such that the area erased as the outside of the original document is the same in all the operation modes. As a result, in the digital multifunction peripheral according to the second configuration example, it is possible to prevent fluctuation from occurring in a result of the outside-of-document erasing processing depending on an operation mode. In other words, in the digital multifunction peripheral according to the second configuration example, it is possible to apply the same outside-of-document erasing processing to input image data irrespective of an operation mode.

A digital multifunction peripheral and a main control unit according to a third configuration example are explained below.

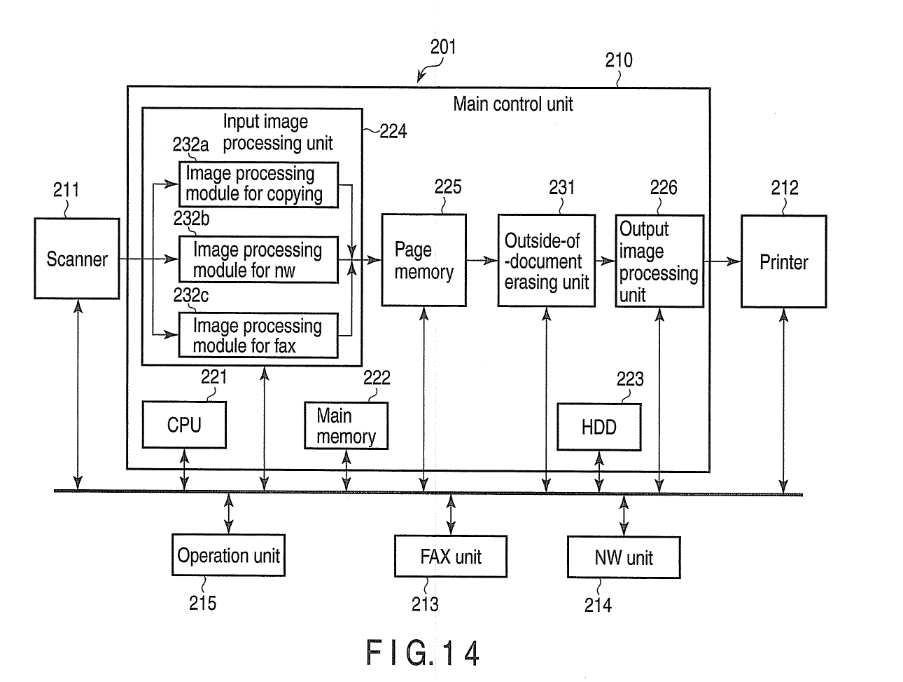

FIG. 14 is a block diagram of a digital multifunction peripheral 201 and a main control unit 210 according to the third configuration example.

As shown in FIG. 14, the digital multifunction peripheral 201 according to the third configuration example includes the main control unit 210, a scanner 211, a printer 212, a facsimile communication unit (a FAX unit) 213, a network communication unit (a NW unit) 214, and an operation unit 215. The scanner 211, the printer 212, the facsimile communication unit (the FAX unit) 213, the network communication unit (the NW unit) 214, and the operation unit 215 are the same as the scanner 11, the printer 12, the FAX unit 13, the NW unit 14, and the operation unit 15 in the digital multifunction peripheral 1 according to the first configuration example shown in FIGS. 1 and 2. Therefore, detailed explanation is omitted concerning the scanner 211, the printer 212, the FAX unit 213, the NW unit 214, and the operation unit 215.

The main control unit 210 according to the third configuration example shown in FIG. 14 has basic functions same as those of the main control unit 10 shown in FIG. 2 explained in the first configuration example. However, the main control unit 210 according to the third configuration example and the main control unit 10 according to the first configuration example are different in a flow of processing for input image data.

As shown in FIG. 14, the main control unit 210 according to the third configuration example includes a CPU 221, a main memory 222, an HDD 223, a scanner-system image processing unit (an input image processing unit) 224, a page memory 225, an image processing unit (an output image processing unit) 226 for a printer system, and an outside-of-document erasing unit 231. The main memory 222, the HDD 223, the page memory 225, and the printer-system image processing unit (the output image processing unit) 226 can be realized as those same as the main memory 22, the HDD 23, the page memory 25, and the output image processing unit 26 explained in the first configuration example shown in FIG. 2. Therefore, detailed explanation is omitted concerning the main memory 222, the HDD 223, the page memory 225, and the output image processing unit 226.

The CPU 221 manages control of the entire digital multifunction peripheral 201. The CPU 221 realizes various functions by executing programs stored in a not-shown program memory. Like the CPU 21 according to the first configuration example, the CPU 221 performs control for realizing a copy function, a facsimile function, and a network scan function. The CPU 221 also has a function of setting, in the outside-of-document erasing unit 231, a reference value for detecting an area on the outside of an original document from image data read out from the page memory 225.

The input image processing unit 224 processes an input image. The input image processing unit 224 shown in FIG. 14 functions as a scanner-system image processing unit that processes an image scanned by the scanner 211 as an input image. Various kinds of image processing of the input image processing unit 224 may be realized by the CPU 221 executing programs for the image processing.

The input image processing unit 224 includes various image processing modules 232a, 232b, and 232c. In the input image processing unit 224 according to the third configuration example shown in FIG. 14, contents of image processing executed by the image processing modules 232a, 232b, and 232c may be the same as the contents of the image processing executed by the image processing modules 32a, 32b, and 32c explained in the first configuration example. Therefore, detailed explanation is omitted concerning the contents of the image processing executed by the image processing modules 232a, 232b, and 232c.

The CPU 221 selects any one of the image processing modules 132a, 132b, and 132c according to an operation mode of the digital multifunction peripheral 101. The image processing module 232a, 232b, or 232c selected according to the operation modes subjects image data scanned by the scanner 211 to the image processing.

The page memory 225 stores image data subjected to the image processing by the image processing modules 232a, 232b, and 232c. For example, the page memory 225 stores image data output from the image processing module 232a as image data for printing, stores image data output from the image processing module 232b as image data for network scan, and stores image data output from the image processing module 232c as image data for facsimile. The page memory 225 can also store image data received by the NW unit 114 through a network or image data received by the FAX unit 113 through facsimile communication.

The outside-of-document erasing unit 231 erases an area on the outside of an original document from image data read out from the page memory 225. The outside-of-document erasing unit 231 can be realized in a configuration same as that of the outside-of-document erasing unit 133 explained in the second configuration example. The outside-of-document erasing unit 231 processes the image data read out from the page memory 225 using a module designated by the CPU 221. In the third configuration, the outside-of-document erasing unit 231 does not process image data directly output from a processing unit corresponding to an operation mode. Like the outside-of-document erasing unit 133, the outside-of-document erasing unit 231 includes the various conversion modules 161a and 161b corresponding to the respective operation modes as the monochromization module group 151. Therefore, the CPU 221 designates a conversion module for monochromizing image data read out from the page memory 225.

The CPU 221 sets a binarization threshold for binarizing monochromized image data in a binarization module. The CPU 221 determines, according to the method explained in the second configuration example, a binarization threshold corresponding to image data to be processed.

For example, when the image data read out from the page memory 225 is image data for printing (i.e., when the operation mode is the copy mode), the CPU 221 designates the first conversion module 161a as a monochromization module in the outside-of-document erasing unit 231 and sets a binarization threshold for the copy mode in the binarization module 152. When the image data read out from the page memory 225 is image data for network scan (i.e., when the operation mode is the network scan mode), the CPU 221 designates the second conversion module 161b as the monochromization module in the outside-of-document erasing unit 231 and sets a binarization threshold for the network scan mode in the binarization module 152. When the image data read out from the page memory 225 is image data for facsimile (i.e., when the operation mode is the facsimile mode), the CPU 221 omits the monochromization module in the outside-of-document erasing unit 231 and sets a binarization threshold for the facsimile mode in the binarization module 152.

A flow of processing in the digital multifunction peripheral 201 according to the third configuration example is explained below.

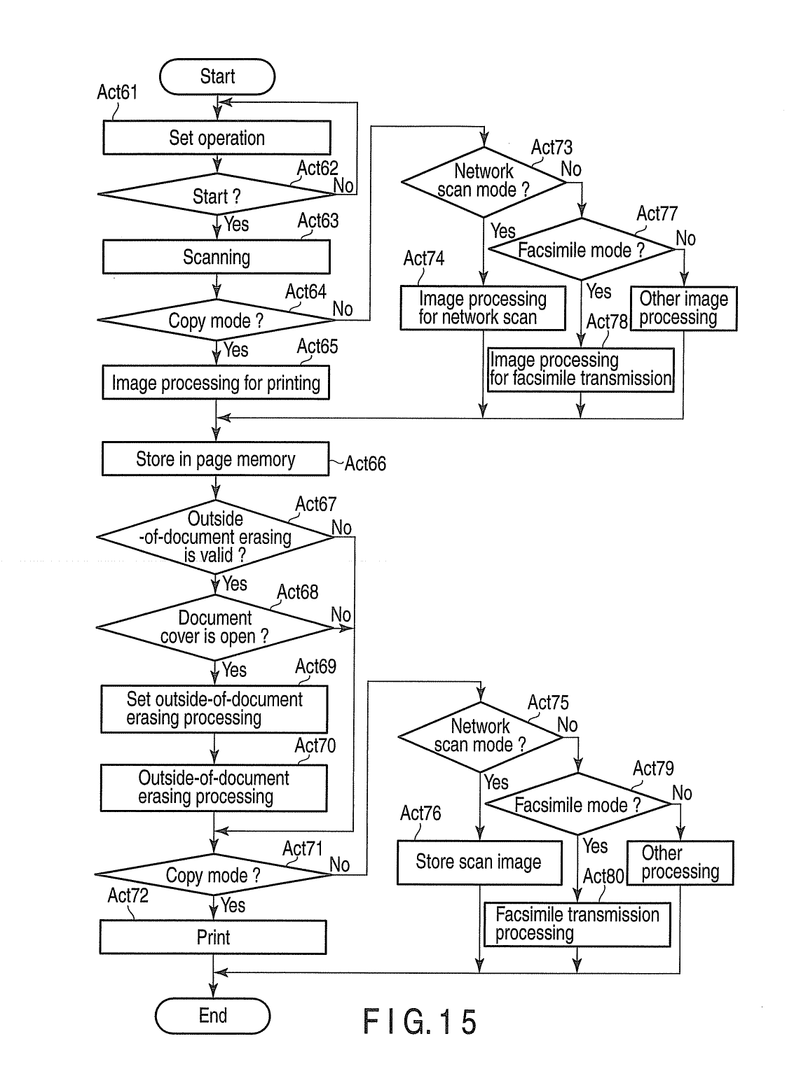

FIG. 15 is a flowchart for explaining a flow of processing including processing for scanning an original document image in the digital multifunction peripheral 201 according to the third configuration example.

When copying, network scan, or facsimile is performed in the digital multifunction peripheral 201, a user sets an original document in the scanner 211 and designates an operation mode using the operation unit 215. In designating an operation mode, the user can also designate whether the outside-of-document erasing processing should be set valid or invalid. The CPU 221 sets the operation mode according to the designation by the user (Act 61). In setting the operation mode, the CPU 221 also sets whether the outside-of-document erasing processing is valid or invalid.

After designating the operation mode, the user enters a start key for instructing the start of scanning of the original document provided in the operation unit 215. When the CPU 221 detects the enter of the start key (Act 62, YES), the CPU 221 starts the scanning of the original document (Act 63). When the operation mode of the digital multifunction peripheral 201 is the copy mode (Act 64, YES), the CPU 221 supplies image data scanned by the scanner 211 to the image processing module for copying 232a. The image processing module for coping 232a applies image processing for printing (for copying) (e.g., color conversion to C, M, and Y signals) to the image data supplied from the scanner 211 (Act 65). As a result, the image processing module for copying 232a generates image data for printing from the image data (a scan image) scanned by the scanner 211.

The page memory 225 once stores the image data for printing, which is generated from the scan image by the image processing module for copying 232a, as a processing result of the input image processing unit 224 (Act 66). The page memory 225 stores the image data for printing from which the area on the outside of the original document is not erased yet.

The CPU 221 determines whether the outside-of-document erasing processing is valid (Act 67). When the outside-of-document erasing processing is valid (Act 67, YES), the CPU 221 determines on the basis of a detection signal of the detector 11c whether the document cover 11b is in the open state (Act 68). When it is determined that the document cover 11b is in the open state (Act 68, YES), the CPU 221 determines that the outside-of-document erasing processing is executed.

In executing the outside-of-document erasing processing, the CPU 221 performs setting for the outside-of-document erasing unit 233 (Act 69). In the digital multifunction peripheral 201 according to the third configuration example, as explained above, as the setting for the outside-of-document erasing unit 233, the CPU 221 selects a conversion module from the monochromization module group 151 according to an operation mode and sets a binarization threshold corresponding to the operation mode in the binarization module 152. When the operation mode is the copy mode, the CPU 221 sets the outside-of-document erasing unit 233 for the copy mode. For example, as the setting for the copy mode, the CPU 221 selects the first conversion module 161a from the monochromization module group 151 and sets a binarization threshold for the copy mode in the binarization module 152.

The outside-of-document erasing unit 233 set for the copy mode by the CPU 221 erases the area on the outside of the original document from the image data read out from the page memory 225 (the image data for printing generated by the image processing module for copying 232a) (Act 70). As explained above, the outside-of-document erasing unit 233 monochromizes the image data for printing, detects an area on the outside of the original document from the monochromized image data, and outputs image data for printing from which the detected area on the outside of the original document is erased. When the operation mode is the copy mode (Act 71, YES), the CPU 221 prints (copies) the image data from which the area on the outside of the original document is erased by the outside-of-document erasing unit 223 on a sheet (Act 72). When the operation mode is the copy mode, the outside-of-document erasing unit 223 according to the third configuration example supplies the image data from which the area on the outside of the original document is erased to the output image processing unit 226. The printer 212 prints the image data, from which the area on the outside of the original document is erased, processed by the output image processing unit 226.

When the operation mode of the digital multifunction peripheral 201 is the network scan mode (Act 73, YES), the CPU 221 supplies the image data scanned by the scanner 211 to the image processing module for NW 232b. The image processing module for NW 232b applies image processing for network scan (for network transfer) (e.g., resolution conversion or image compression corresponding to user designation) to the image data supplied from the scanner 211 (Act 74). As a result, the image processing module for NW 232b generates image data for network scan from the image data (a scan image) scanned by the scanner 211.

The page memory 225 once stores the image data for network scan, which is generated from the scan image by the image processing module for NW 232b, as a processing result of the input image processing unit 224 (Act 66). In the network scan mode, the page memory 225 stores the image data for network scan from which the area on the outside of the original document is not erased yet.

On the other hand, as explained above, the CPU 221 determines whether the outside-of-document erasing processing should be executed (Acts 67 and 68). When it is determined that the outside-of-document erasing processing is executed in the network scan mode, the CPU 221 sets the outside-of-document erasing unit 133 according to network scan (Act 69). For example, as the setting for network scan, the CPU 221 selects the second conversion module 161b from the monochromization module group 151 and sets a binarization threshold for the network scan mode in the binarization module 152. The outside-of-document erasing unit 233 set for network scan erases the area on the outside of the original document from the image data read out from the page memory 225 (the image data for network scan generated by the image processing module for NW 232b) (Act 70).

When the operation mode is the network scan mode (Act 75, YES), the CPU 121 transfers the image data from which the area on the outside of the original document is erased by the outside-of-document erasing unit 223 (the image data as a scan result from which the area on the outside of the original document is erased) to a storage destination designated by the user or stores the image data (Act 76). For example, when the image data is stored in a user terminal as an external apparatus on a network, the network interface 214 transfers the image data output from the outside-of-document erasing unit 233 to the user terminal.

When the operation mode of the digital multifunction peripheral 201 is the facsimile mode (Act 77, YES), the CPU 221 supplies the image data scanned by the scanner 211 to the image processing module for FAX 232c. The image processing module for FAX 232c applies image processing for facsimile (facsimile transmission) (e.g., monochrome conversion) to the image data supplied from the scanner 211 (Act 78). As a result, the image processing module for FAX 232c generates image data for facsimile from the image data scanned by the scanner 211.

The page memory 225 once stores the image data for facsimile, which is generated from the scan image by the image processing module for FAX 232c, as a processing result of the input image processing unit 224 (Act 66). In the facsimile mode, the page memory 225 stores the image data for facsimile from which the area on the outside of the original document is not erased yet.

On the other hand, as explained above, the CPU 221 determines whether the outside-of-document erasing processing should be executed (Acts 67 and 68). When it is determined that the outside-of-document erasing processing is executed in the facsimile mode, the CPU 221 sets the outside-of-document erasing unit 233 according to the facsimile mode (Act 69). For example, as the setting for the facsimile mode, the CPU 221 omits the respective conversion modules of the monochromization module group 151 and sets a binary threshold for the facsimile mode in the binarization module 152. The outside-of-document erasing unit 233 set for the facsimile mode erases the area on the outside of the original document from the image data read out from the page memory 225 (the image data for facsimile generated by the image processing module for FAX 232c) (Act 70).

When the operation mode is the facsimile mode (Act 79, YES), the CPU 221 transmits by facsimile the image data from which the area on the outside of the original document is erased by the outside-of-document erasing unit 223 (image data for facsimile transmission from which the area on the outside of the original document is erased) to a telephone number designated by the user (Act 80).

As explained above, in the digital multifunction peripheral according to the third configuration example, the image data scanned by the scanner is processed by the image processing units corresponding to the various operation modes and stored in the page memory and, when the image data stored in the page memory is read out, the area on the outside of the original document is erased from the image data by the outside-of-document erasing unit set according to an operation mode. The outside-of-document erasing unit is set according to the operation modes (contents of image processing carried out before the document data is stored in the page memory) such that the area erased as the outside of the original document is the same in all the operation modes. As a result, in the digital multifunction peripheral according to the third configuration example, it is possible to prevent fluctuation from occurring in a result of the outside-of-document erasing processing depending on an operation mode. In other words, in the digital multifunction peripheral according to the third configuration example, it is possible to apply the same outside-of-document erasing processing to input image data irrespective of an operation mode. Further, in the digital multifunction peripheral according to the third configuration example, since the outside-of-document erasing processing is applied to the image data read out from the page memory, it is possible to easily apply the outside-of-document erasing processing to image data supplied from apparatuses other than the scanner.

Setting of intensity for determining an area on the outside of an original document is explained below.

A processing procedure for setting intensity (hereinafter also referred to as adjustment level) for determining an area on the outside of an original document on the basis of operation by the user is explained. Setting of the adjustment level explained below can be applied to each of the digital multifunction peripherals according to the first to third configuration examples.

As explained above, in each of the digital multifunction peripherals according to the first to third configuration examples, one adjustment level is set and the same result of the outside-of-document erasing processing (image data from which the same area is erased as an area on the outside of an original document) is obtained in the various operation modes. This means that an adjustment level designated by the user is common to the operation modes. In other words, the user designate one adjustment level common to the operation modes without designating an adjustment level for each of the operation modes.

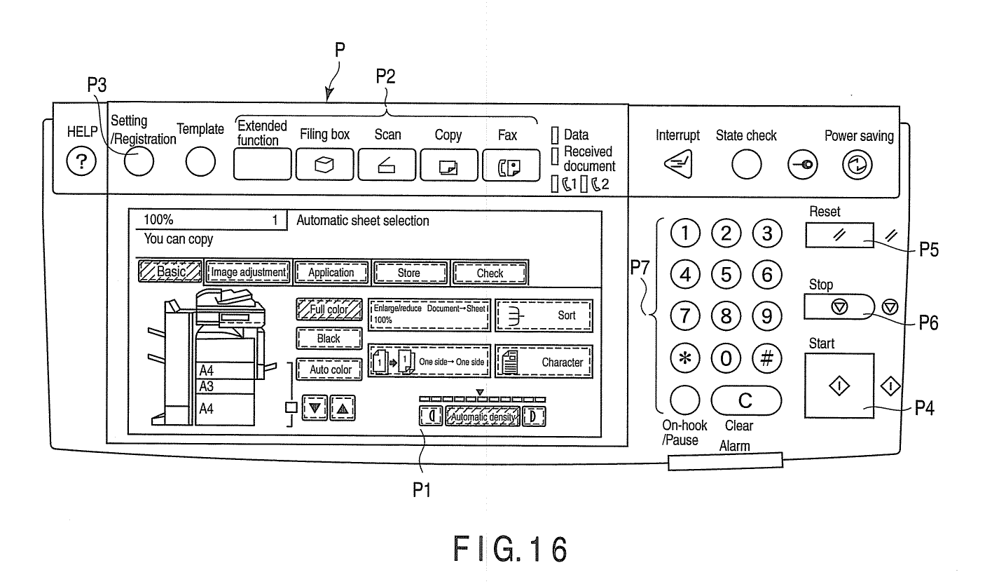

FIG. 16 is an external view for explaining an overall configuration of an operation panel P serving as the operation units 15, 115, and 215.

As shown in FIG. 16, the operation panel P includes a display section P1, a function selection key P2, a setting key P3, a start key P4, a reset key P5, a stop key P6, and a ten key P7.

The display section P1 includes a liquid crystal display device incorporating a touch panel. The display section P1 displays operation guidance for the user and displays various operation screens including icons that can be operated through the touch panel. For example, in a standby state of the digital multifunction peripheral, the display section P1 displays a basic menu screen shown in FIG. 16. The basic menu screen shown in FIG. 16 is a basic menu screen in the copy mode.

The display section P1 also has a function of displaying image data. For example, the display section P1 can display a preview image with which the user checks an image. For example, the display section P1 can display, as the preview image, image data (a scan image) scanned by the scanner of the digital multifunction peripheral or an image after being subjected to image processing.

The function selection key P2 is a hard key for selecting various functions. As the function selecting key P2, for example, a scan mode selection key for selecting the scan mode, a copy mode selection key for selecting the copy mode, a facsimile mode selection key for selecting the facsimile mode, and the like are provided.

The setting key P3 is a key for performing various kinds of setting in the digital multifunction peripheral. When the setting key P3 is entered, the digital multifunction peripheral shifts to a setting processing mode. Items to be set by the setting key P3 are mainly items concerning default setting values. Contents set after the enter of the setting key P3 are stored as default setting values and reflected on the processing in the digital multifunction peripheral. For example, a default value of intensity (an adjustment level) for determining an area on the outside of an original document is set in a setting screen displayed on the display section P1 when the setting key P3 is entered.

The start key P4 is a hard key for instructing the start of processing (e.g., scan start). For example, in the copy mode, copying (scanning) is started according to the enter of the start key P4. The reset key P5 is a hard key for instructing reset of setting contents and the like. For example, setting and the like input through the touch panel of the display section P1 are reset according to the reset key. The stop key P6 is a hard key for instructing suspension of an operation being executed by the digital multifunction peripheral. For example, when the stop key P6 is entered during a copy operation of the digital multifunction peripheral, the copy operation is suspended. The ten key P7 is a hard key for inputting numbers and the like. The ten key P7 is used for inputting information such as the number of copies and a department code.

In the operation panel P shown in FIG. 16, besides the various keys explained above, a help (HELP) key for instructing display of a user guide, a setting and registration key for instructing execution of setting or registration, a template key for selecting a template as data registered in advance, an interrupt key for requesting interrupt of an operation, a state check key for checking a state of the digital multifunction peripheral, a key for performing security setting and the like, a power save key for switching a power save operation mode for reducing power consumption and a normal operation mode, an on-hook and pause key for setting an on-hook state as a telephone function, a clear key for clearing numbers and the like input by the ten key and the like, an alarm indicator for informing abnormality in the digital multifunction peripheral.

Setting of an adjustment level performed by using the operation panel P is explained below.

When the setting key P3 is entered in the operation panel P, the display section P1 displays a default setting screen for setting default values of the various functions. The default setting screen may be a screen for setting default values set for each of users or may be a screen for setting default values common to all the users. In both the cases, intensity (an adjustment level) for determining an area on the outside of an original document is not set for each of the operation modes but are set as a value common to all the operation modes.

In each of the digital multifunction peripherals according to the first to third configuration examples, image data from which the same area on the outside of an original document is erased is obtained as a result of the outside-of-document erasing processing in all the operation modes. In other words, when a default value of intensity (an adjustment level) for determining an area on the outside of an original document is set, the user set one adjustment level for the digital multifunction peripheral. Therefore, default setting concerning intensity for determining an area on the outside of an original document is not instructed by the user on a setting screen for the operation modes (e.g., the setting screen to which the digital multifunction peripheral shifts from the function selection key P2) but is instructed by the user on a setting screen to which the digital multifunction peripheral shifts from the setting key P3.

For example, a default setting screen displayed according to the enter of the setting key P3 includes an icon for default setting concerning the outside-of-document erasing processing. When the icon for outside-of-document erasing setting is selected, the display section P1 displays a setting screen on which the user designates an adjustment level as intensity for determining an area on the outside of an original document (a setting screen for an adjustment level).

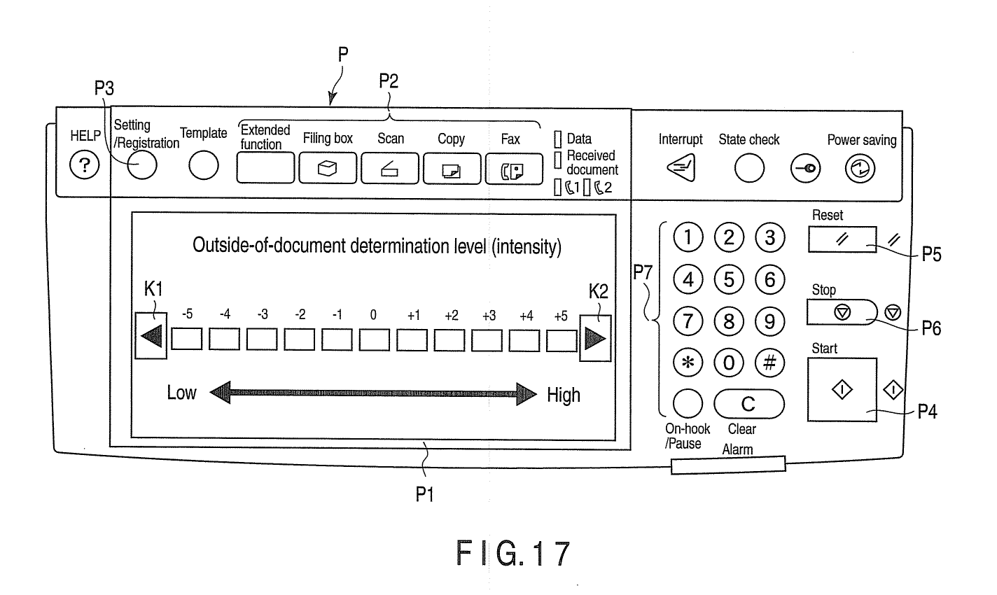

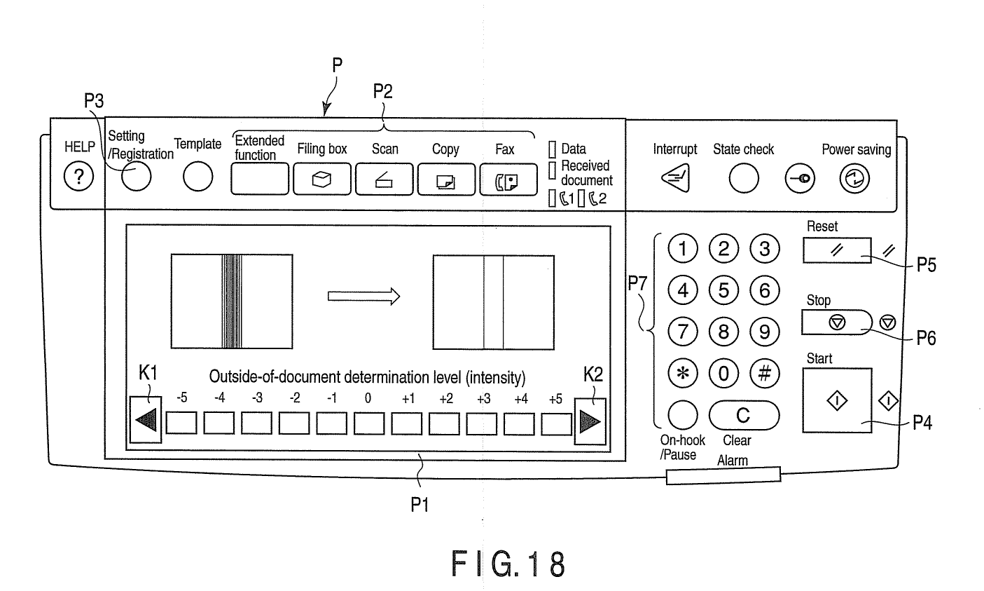

FIGS. 17 and 18 are diagrams of display examples of the setting screen for an adjustment level.

The display example shown in FIG. 17 is an example in which the setting screen on which the user designates intensity for determining an area on the outside of an original document is displayed on the display section P1. In the setting screen shown in FIG. 17, the user can designate, as intensity (an adjustment level) for determining an area on the outside of an original document, a desired adjustment level from five levels (“+1” to “+5”) higher than a predetermined reference level (“0”) and five levels (“−1” to “−5”) lower than the reference level. Every time the user touches an icon K1 arranged on a left end side in the setting screen shown in FIG. 17, the adjustment level is changed to a lower level step by step. Every time the user touches an icon K2 arranged on a right end side in the setting screen shown in FIG. 17, the adjustment level is changed to a higher level step by step. In other words, the user can visually and intuitively adjust the adjustment level easily according to the number of times the user touches the icons K1 and K2 arranged at both the ends.

The display example shown in FIG. 18 is an example in which a setting screen for the outside-of-document determination level shown in FIG. 17 is displayed in an area on a lower side of the display section P1 and a preview screen for image data is displayed in an area on an upper side of the display section P1. In the display example shown in FIG. 18, image data from which an area on the outside of an original document is not erased yet and the image data from which the area on the outside of the original document is erased are displayed on the preview screen. In the display example shown in FIG. 18, the image data displayed on the preview screen may be image data stored in the HDD or the like in advance or may be image data obtained by scanning an original set by the user with the scanner. Since the display example shown in FIG. 18 is the setting screen for adjusting default setting for outside-of-document erasing, an area to be erased as the outside of the original document may be highlighted on the preview screen.

In the display example shown in FIG. 18, every time the adjustment level is changed, each of the outside-of-document erasing units 31, 133, and 231 performs the outside-of-document erasing processing at the changed adjustment level. The image data obtained by such outside-of-document erasing processing is displayed on the preview screen as an image subjected to the outside-of-document erasing processing at an adjustment level designated by the user. In the display example shown in FIG. 18, every time the user changes the adjustment level, an image as a result of performing the outside-of-document erasing processing at the changed adjustment level is displayed. With the preview screen explained above, the user can visually and specifically recognize a state of an area to be erased by processing carried out at the designated adjustment level.

Each of the digital multifunction peripherals according to the first to third configuration examples may display the preview screen on the display section P1 not only during the default setting but also when processing including the outside-of-document erasing processing is executed. The user selects whether such a preview screen should be displayed.

For example, when a user who desires to check a state of the outside-of-document erasing processing on the preview screen executes the various kinds of processing, the user turns on a preview button provided in the operation panel P. When the preview button is ON, the display section P1 of the operation panel P displays image data after the outside-of-document erasing processing on the preview screen before the image data is actually processed. For example, when the preview button is ON in the copy mode, the display section P1 displays image data after the outside-of-document erasing processing on the preview screen before printing is executed. When an image displayed on such a preview screen is satisfactory, the user instructs execution of the processing by entering a not-shown execution start key. When the image displayed on the preview screen is dissatisfactory, the user stops the processing indicated by the image by entering a not-shown processing stop key. In this case, the digital multifunction peripheral may perform rescanning of the original document.

Whether the preview screen is set valid may be set as default concerning the outside-of-document erasing processing. For the setting, the user only has to designate presence or absence of preview check during execution of processing on the setting screen for the outside-of-document erasing processing. When the preview check is set valid in the default setting, in the processing including the outside-of-document erasing processing, the display section P1 displays image data after the outside-of-document erasing processing on the preview screen before processing (e.g., printing) is performed by using the image data after the outside-of-document erasing processing. As a result, the user can check image data obtained by the outside-of-document erasing processing before executing the various kinds of processing using an input image.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image processing apparatus comprising:
a scanner that scans an image of an original document;
plural processing units that process image data according to various operation modes;
plural image converting units that convert image data scanned by the scanner into image data to be processed in processing units corresponding to the operation modes;
an outside-of-document erasing unit that erases, as an area on the outside of the original document image, a same area irrespective of contents of image conversion processing in the respective image converting units from the image data; and
a control unit that supplies the image data from which the area on the outside of the original document image is erased by the outside-of-document erasing unit and that is processed by the image converting unit corresponding to an operation mode designated by a user to the processing unit corresponding to the operation mode.

2. The apparatus according to claim 1, wherein
the scanner scans an image of spread two pages in a book set in a spread state,
the outside-of-document erasing unit erases an area around a boundary of both the spread pages as an area on the outside of the original document image, and
the area to be erased as the area on the outside of the original document image is the same irrespective of contents of the image conversion processing in the image converting units.

3. The apparatus according to claim 2, wherein width of the area around the boundary to be erased as the area on the outside of the original document is the same irrespective of contents of the image conversion processing in the image converting units.

4. The apparatus according to claim 1, wherein
the operation modes include a copy mode, and
the plural processing units include a printer that prints an image scanned by the scanner on a sheet.

5. The apparatus according to claim 1, wherein
the operation modes include a network scan mode, and
the plural processing units include a network interface for transmitting image data through a network.

6. The apparatus according to claim 1, wherein
the operation modes include a facsimile mode, and
the plural processing units include a facsimile interface for transmitting image data by facsimile.

7. The apparatus according to claim 1, wherein the outside-of-document erasing unit is provided at a pre-stage of the image converting units and supplies image data obtained by erasing the area on the outside of the original document image from input image data to the image converting units.

8. The apparatus according to claim 1, wherein the outside-of-document erasing unit is provided at a post-stage of the image converting units and erases, on the basis of a reference value for erasing a same area as an area on the outside of the original document image irrespective of processing contents in the image converting units, the area on the outside of the original document image from the image data subjected to the conversion processing in the image converting units.

9. The apparatus according to claim 8, further comprising a storing unit that stores, in association with the operation modes, a reference value for each of the operation modes for erasing the same area as the area on the outside of the original document image irrespective of the processing contents in the image converting units, wherein
the outside-of-document erasing unit erases, on the basis of the reference value corresponding to the operation modes stored in the storing unit, the area on the outside of the original document image from the image data subjected to the conversion processing in the image converting units.

10. The apparatus according to claim 1, further comprising a page memory that stores the image data subjected to the conversion processing in the image converting units, wherein
the outside-of-document erasing unit is provided at a post stage of the page memory and erases, on the basis of a reference value for erasing a same area as an area on the outside of the original document image irrespective of processing contents in the image converting units, the area on the outside of the original document image from the image data read out from the page memory.

11. The apparatus according to claim 10, further comprising a storing unit that stores, in association with the operation modes, a reference value for each of the operation modes for erasing the same area as the area on the outside of the original document image irrespective of the processing contents in the image converting units, wherein
the outside-of-document erasing unit erases, on the basis of the reference value corresponding to the operation modes stored in the storing unit, the area on the outside of the original document image in the image data read out from the page memory.

12. The apparatus according to claim 1, further comprising a display unit that displays a setting screen on which a user designates intensity for detecting an area on the outside of the original document image, wherein
the outside-of-document erasing unit detects an area on the outside of the original document image in the image data such that an area on the outside of the original document image detected at the intensity designated by the user on the setting screen is a same area irrespective of contents of the image conversion processing in the image converting units and erases the detected area on the outside of the original document image from the image data.

13. The apparatus according to claim 12, wherein the display unit displays a setting screen on which the user designates the intensity for detecting an area on the outside of the original document image from plural levels.

14. The apparatus according to claim 12, wherein the display unit displays an image indicating an area on the outside of the original document image to be erased at the intensity designated by the user.

15. The apparatus according to claim 1, further comprising a display unit that displays, before the processing by the processing units, an image from which the area on the outside of the original document image is erased by the outside-of-document erasing unit, wherein
the control unit supplies, when contents displayed on the display unit are checked by the user, the image data to the processing unit corresponding to the operation mode.

16. An image processing method comprising:
acquiring image data;
converting the acquired image data into image data corresponding to an operation mode designated by a user;
erasing an area on the outside of an original document image from the acquired image data with outside-of-document erasing processing for erasing, as an area on the outside of an original document image, a same area irrespective of contents of conversion processing for image data corresponding to various operation modes; and
performing, using the image data from which the area on the outside of the original document image is erased and that is converted into the image data corresponding to the operation mode designated by the user, processing corresponding to the operation mode.

17. The method according to claim 16, wherein
the acquired image data is an image obtained by scanning an image of spread two pages in a book set in a spread state using a scanner, and
the outside-of-document erasing processing is processing for erasing an area around a boundary of both the spread pages as an area on the outside of the original document image.

18. The method according to claim 17, wherein the outside-of-document erasing processing is processing with which width of the area around the boundary to be erased as the area on the outside of the original document image is the same irrespective of contents of the image conversion processing in the image converting units.

19. The method according to claim 16, wherein
the erasing the area on the outside of the original document image is executed on the acquired image data before the acquired image data is converted into the image data corresponding to the operation mode designated by the user, and
the converting the acquired image data into the image data corresponding to the operation mode designated by the user is executed on the image data obtained by erasing the area on the outside of the original document image from the acquired image data.

20. The method according to claim 16, wherein the erasing the area on the outside of the original document image is executed on the image data after being converted into the image data corresponding to the operation mode designated by the user on the basis of a reference value corresponding to the operation mode designated by the user among reference values corresponding to the operation modes for erasing a same area as an area on the outside of the original document image irrespective of contents of conversion processing for image data corresponding to various operation modes.

21. The method according to claim 16, further comprising storing, in a page memory, the image data obtained by converting the acquired image data into the image data corresponding to the operation mode, wherein
the erasing the area on the outside of the original document image is executed on the image data read out from the page memory on the basis of a reference value corresponding to the operation mode designated by the user among reference values corresponding to the operation modes for erasing a same area as an area on the outside of the original document image irrespective of contents of conversion processing for image data corresponding to various operation modes.

22. The method according to claim 16, further comprising displaying a setting screen on which the user designates intensity for detecting an area on the outside of the original document image, wherein
the erasing the area on the outside of the original document image is detecting an area on the outside of the original document image in the acquired image data and erasing the detected area on the outside of the original document image from the image data such that an area on the outside of the original document image detected at the intensity designated by the user on the setting screen is a same area irrespective of contents of the image conversion processing in the image converting units.

23. The method according to claim 22, wherein an image indicating the area on the outside of the original document image erased at the intensity designated by the user is displayed on the setting screen.

24. The method according to claim 16, further comprising displaying, before processing corresponding to the operation mode, an image from which the area on the outside of the original document image is erased, wherein
the processing corresponding to the operation mode is executed when the displayed image is checked by the user.
